(19) United States
(12) Patent Application Publication
(10) Pub. No.: US 2022/0298076 A1
(43) Pub. Date: Sep. 22, 2022

(54) SETTLEMENT SUBSTRATE OF PORTLAND CEMENT CONCRETE OR LIGHTWEIGHT CONCRETE FOR OYSTER AND PREPARATION METHOD THEREOF

(71) Applicant: Jianfu LV, Harbin (CN)

(72) Inventors: Jianfu LV, Harbin (CN); Xinyu HU, Harbin (CN); Xiaobing MA, Harbin (CN)

(73) Assignee: Jianfu LV, Harbin (CN)

(21) Appl. No.: 17/831,238

(22) Filed: Jun. 2, 2022

Related U.S. Application Data
(63) Continuation of application No. PCT/CN2020/133097, filed on Dec. 1, 2020.

(30) Foreign Application Priority Data
Dec. 2, 2019 (CN) 201911210477.1
Dec. 2, 2019 (CN) 201911210488.X

(51) Int. Cl. C04B 28/04; C04B 14/06; C04B 18/04; C04B 22/10; C04B 14/28; C04B 24/42; C04B 40/00; A01K 61/54; A01K 61/70; B28B 11/24

(52) U.S. Cl. CPC C04B 28/04; C04B 14/06; C04B 18/0427; C04B 22/106; C04B 14/28; C04B 24/42; C04B 40/0046; A01K 61/54; A01K 61/70; B28B 11/245; C04B 2111/2092

(57) ABSTRACT

The present disclosure relates to an oyster settlement substrate technology, and particularly relates to a settlement substrate of Portland cement concrete and lightweight concrete for oyster and a preparation method thereof. According to the settlement substrate for inducing marine sessile organisms, an inducer is mixed to greatly improve the capability of rapid induction of settlement and metamorphosis of sessile organisms and promotion of long-term growth, and other properties of concrete are basically not affected; and the settlement substrate for inducing the marine sessile organisms can be used for construction of marine ecological engineering and corrosion prevention of marine concrete engineering.

This application is a continuation of a PCT application with an Application Number PCT/CN2020/133097 filed on Dec. 1, 2020, which claims the priority of a Chinese patent application 201911210488.X filed on Dec. 2, 2019; and, Chinese patent application 201911210477.1 filed on Dec. 2, 2019, and the entire disclosures of which are incorporated by reference in this application for all purposes.

### TECHNICAL FIELD

The present disclosure relates to an oyster settlement substrate technology, particularly relates to a settlement substrate of Portland cement concrete or lightweight concrete for oyster and a preparation method thereof, which belongs to the cross field of marine sessile organisms and concrete.

### BACKGROUND

With the improvement of the living standard of people, the consumption demand for oysters serving as healthy food on dining tables is increasing. A traditional small-scale culture method cannot meet the growing demand for oyster. Meanwhile, with the increase of the amount of oyster reef restoration and the coming of oyster reef-like marine ecological engineering construction, the demand for an oyster settlement substrate is increasing. Common culture methods include bamboo inserting culture, bottom culture, strip stone and vertical stone culture, hanging drop culture and the like, but there is the problem that oysters need a long time to reach a satisfactory settlement rate on the settlement substrate. In addition, due to the increase of the culture amount of oysters, the oyster settlement substrate of shells such as Azumapecten farreri cannot meet the requirement of oyster larvae culture, which leads to an increase in the price of oyster settlement substrate of shells. Moreover, in the CN106719186 patent invented by Ocean University of China recently, a novel oyster settlement substrate is prepared by adding 15-20% shell powder (by weight of cement paste) and 5-15% shell fragments. Due to the addition of oyster shell fragments, the surface of the settlement substrate becomes rougher, which increases the number of settled oysters. Compared with a method for Azumapecten farreri, this method is more convenient to collect oyster larvae, and the settlement effect of oyster larvae is better. However, the water consumption control conducted through a water reducing agent and the curing are not considered, and the water-cement ratio and curing determine the permeability of concrete. A large amount of alkali contained in the settlement substrate can be released, consequently, the alkalinity of seawater making contact with the settlement substrate is increased, and settlement of marine sessile organism larvae is restrained. Especially when larvae are cultured in a larva culture pond, the situation that the pH value of water is increased due to the small water mass, and consequently the oyster larvae die is likely to happen. Meanwhile, due to the fact that a large amount of shell powder is added, the color of the cement settlement substrate becomes light from dark gray, and settlement of the oysters is not facilitated.

Concrete has the advantages of simple processing, easy settlement of larvae, easy removing of a substrate, wide range of materials and low cost. However, the problems like immature research on the concrete settlement substrate and high pH have caused high morality of larvae. Concrete can be put into use only after being soaked in seawater for more than one year. In addition, the existing method of inducing marine organisms by ions is mainly applied to laboratory test; its defects of high cost and difficulty in control have always restricted the development and application of the technology of inducing marine organisms by ions. Therefore, it is imperative to invent a concrete with low alkalinity and high induction efficiency as a substrate to induce oyster to settle.

In recent decades, the rapid development of coastal economy and neglect of environmental protection have caused large-scale destruction of coastal ecology, and have had a huge impact on the ecology and economy of coastal areas in China. At present, with the introduction of a series of related national policies, marine engineering construction in China will come to a peak period, but large-scale marine engineering construction and breakwaters for guaranteeing the stability of surrounding sea areas further destroy the fragile ecosystem of the sea. If appropriate ecological environment protection cannot be performed, larger disasters will be brought to the ecology of the ocean coasts. Meanwhile, most coastal infrastructures cannot be dismantled, and the ecology of the sea areas where the infrastructures are located needs to be restored, people gradually have the consciousness of applying the ecological technology on a large number of infrastructures to effectively improve or restore the ecology of the sea areas. Therefore, it is very important and urgent to construct breakwaters with good ecological effect or perform ecologicalization on existing breakwater to improve the offshore ecological environment at present. However, as of now, the ecological technology of engineering in the tidal range area such as breakwaters is still blank in China.

Oysters called “ecological engineers” are mainly concentrated in the tidal range area and within 30 m underwater, and meanwhile, the oysters prefer to settle on shells of the same kind to form thick oyster reefs, thus the oysters can compactly settle on the breakwater, and the ecologicalization of the breakwater can be realized. In addition, existing oyster reefs are seriously damaged, and most of the oyster reefs need the large-scale settlement of oysters again to achieve ecological restoration. Both marine ecological engineering construction and oyster reef restoration can achieve their ecological functions through the mass reproduction of oysters. Therefore, there will be a huge demand for the concrete settlement substrate. At present, related researches on oyster settlement at home and abroad are as follows.

### I. Influence of Ions on Settlement and Metamorphosis of Marine Sessile Organism Larvae

The research on the settlement and metamorphosis induction of the marine sessile organism larvae at home and abroad mainly focuses on the influence of the ion concentration in a solution on the marine sessile organism larvae. The ions and substances in deep research include K⁺, NH₃, Ca²⁺ and Cu²⁺, the first three ions or substances can promote the settlement or metamorphosis of oysters at appropriate concentration, but the promotion effect of the Ca²⁺ is not obvious, and even the mortality of the larvae is increased by the Ca²⁺ at high concentration. The K⁺ induces the metamorphosis of the larvae by influencing the behavior of cell membranes. The NH3 enters cells, thereby causing the increase of pH values in the cells, which subsequently causes the depolarization of neurons in a behavior pathway and further induces sessile metamorphosis. Although many researches on the settlement and metamorphosis of sessile organisms on the surfaces of different substances such as polyethylene plates, shells and tiles have been carried out in the solution, such methods are difficult to realize or the cost is too high when applied in actual marine concrete engineering.

At present, with the extensive application of concrete in ocean engineering, especially in recent oyster reef restoration engineering and the like, concrete has become one of the most commonly used substrate material for settlement of marine sessile organisms. However, the concrete material is very different from traditional shells, limestone, rubber tires, plastic plates and the like. The concrete has high alkalinity and high calcium ions, is also rich in other ions such as potassium ions and sodium ions, which have a great impact on the settlement and growth of oysters. At present, although some oyster reef restoration engineering and the like adopt newly-made concrete members, waste concrete and the like as restoration substrates, the effect is not ideal.

### II. Influence of Concrete of Different Cement Types on Marine Plants and Sessile Organisms

At present, almost all marine concrete engineering adopt Portland cement concrete, Portland cement concrete has high alkalinity (the pH value of a pore solution is generally 12.0-13.0), and the pH value of seawater is generally 7.9-8.4. Due to the existence of alkali concentration gradient, concrete in contact with seawater can continuously release alkali, further the pH value of the seawater in the sea area is increased, and a local ecosystem is destroyed. The Portland cement concrete has a greater inhibition effect on the settlement growth of the sessile organisms on its surface, and particularly has great influence on alkalinity-sensitive organisms. The current researches at home and abroad show that artificial reefs manufactured through concrete of different cement types have significant difference in organism settlement effect, artificial reefs manufactured through aluminate cement and fly ash Portland cement have good organism settlement effect, and the aluminate cement and fly ash Portland cement have alkalinity lower than common Portland concrete[1]. Similarly, the cement concrete in which 40-60% of fly ash and slag powder are mixed has a good ecological effect. In addition, the variety and the number of the organisms settled on the concrete of a glued stone cementitious material are more than those on the cement concrete, and the higher the content of the glued stone cementitious material is, the better the ecological effect is. The low-alkalinity cement concrete is adopted in ecological concrete engineering construction in USA, such as aluminate cement, particularly slag Portland cement, wherein the substitution amount of the slag powder reaches 50%, and the slag Portland cement has a better ecological effect of enriching marine plants, animals and the like[2,3]. By adopting the cement with lower alkalinity to prepare concrete, the amount of the alkalinity-sensitive organisms (mainly marine plants) can be effectively increased, but the increase of the settlement amount and the settlement compactness of oysters is limited.

### III. Influence of Calcium Substances on Settlement Off Marine Sessile Organisms

The researches at home and abroad show that the chemical element composition of the settlement substrate significantly influences the settlement, metamorphosis and later growth of oyster larvae. The most common calcium-containing substrate (limestone and concrete) can effectively induce the oyster larvae to settle, and the induction effect of the substrate is equivalent to that of shells. It indicates that the calcium element plays a crucial role in the settlement, metamorphosis and growth of the oyster larvae.

Recently, except for conventional substrates, people have added calcium substances into cement-based materials to increase the content of calcium in concrete so as to research the settlement condition of oyster larvae. In current research, 80-mesh bovine bone powder, calcium carbonate powder and gypsum powder (the mixing amount is 62.5% and 375% of the weight of cement) are separately doped into mortar for an oyster settlement experiment, and the induction capacity of calcium morphogenesis to settlement of the oyster larvae under the same condition is obtained and as shown in the sequence of bovine bone powder>calcium carbonate=calcium sulfate; the mixing amount of the calcium carbonate powder is 5-60% of the weight of the mortar (41.7-500.0% of the weight of the cement), and the effect is the best when the mixing amount is 20% (166.7% of the weight of the cement). Although the settlement amount of oysters can be increased by mixing the bovine bone powder, the calcium carbonate powder and the gypsum powder, the mixing proportion is too large (the weight of the calcium powder is larger than 41.7% of the weight of the cement and even reaches 500.0%), the mechanical properties and durability of the concrete are seriously affected, and the concrete is not suitable for concrete engineering in the marine environment. In addition, although the bovine bone powder has a good induction effect on settlement of the oysters, the concrete will get mildew when the mixing amount exceeds 10% of the weight of the cement. Therefore, although the bovine bone powder, the calcium carbonate powder and other calcium substances are doped into the concrete at present, the influence of the marine environment on the durability of the concrete structure is not considered, the concrete cannot be applied in the severe marine environment at all.

In a patent CN104529286, from the perspective of waste utilization, 5-8 mm oyster shell fragments accounting for 10-20% of the mass of cement are mixed into an artificial reef to obtain concrete which does not affect biological settlement and does not pollute the environment. In a patent CN104938384, 150-200-mesh biological calcium carbonate powder (ratio of fishbone to coral to eggshell to shell is 1:1:1:1) accounting for 10-20% of the mass of cement and shell fragments are mixed into the artificial reef at the same time, it is shown that the amount of induced organisms is gradually increased along with increase of the mixing amount of the biological calcium carbonate powder, and the amount of organisms (marine plants and marine organisms) induced by biological calcium carbonate is the largest when the mixing amount is the largest (20% of the weight of cement). Similarly, the surface alkalinity of the concrete artificial reef is reduced, thus microorganisms and algae are settled more easily, the amount of organisms and the population quantity are increased, and the fish gathering effect is better. The precipitates of a biological calcium carbonate cement mortar covering layer are harmless to the environment and organisms. Although the biological calcium carbonate powder, the oyster shell fragments and the like are mixed into the concrete for artificial reef manufacturing and biological settlement experiments, the biological calcium carbonate powder really enhances the enrichment effect of the organisms, specifically the marine plants and the microorganisms.

In conclusion, the calcium content is very important for the settlement of the oyster larvae, and some experimental results at present also prove that the settlement and the growth of the oyster larvae can be promoted by adding a proper dosage of calcium carbonate substances into the cement-based material. However, cement concrete contains a large number of calcium ions, the pH value in the pore solution is generally greater than 12.5, and the pH value of a saturated calcium hydroxide solution is about 12 at normal temperature, thus the concentration of the calcium ions in the pore solution of the concrete is about 5 mmol/L; and the solubility of calcium carbonate is very small and is only 9.5×10−5 mol/L (9.5×10−2 mmol/L) at 25° C. At present, the optimal range of the concentration of the calcium ions for inducing the settlement of the oysters is 10-25 mmol/L, and even if the oyster larvae are placed in the saturated calcium carbonate solution, the concentration of Ca²⁺ is not enough to provide the appropriate ion concentration for the settlement of the oysters. Further, Ca(OH)₂ in the cement concrete can be released more quickly, and the dissolution of the calcium carbonate need a longer time. Therefore, it can be understood that the calcium carbonate material added into the concrete can promote the settlement of the oyster larvae, and the Ca2+ does not play a leading role.

In addition, the mixing amount of shell powder is too large, the weight ratio of the shell powder relative to cement is larger than 10% and even reaches 500%, so it has a huge influence on the durability of the concrete. Although a proper amount of calcium carbonate materials can be mixed to maintain the impermeability of the concrete or make the impermeability of the concrete better, too large mixing amount is very adverse to the resistance of the concrete to sulfuric acid corrosion and sulfate corrosion in seawater.

Therefore, there are many problems in mixing calcareous substances such as biological calcium carbonate powder, bovine bone powder and calcium carbonate powder into the concrete for inducing the marine sessile organism larva to settle, especially the problems of concrete property change caused by the too large mixing amount of the calcareous materials, mildewing caused by the addition of the bovine bone powder, etc.

### V. Influence of Color on Settlement of Marine Sessile Organisms

The color of the substrate has certain influence on settlement, metamorphosis and growth of marine sessile organism larvae. It has been reported abroad that dark substrate can promote growth of oysters in sea areas with lower temperature. Domestic researches have shown that oyster larvae have certain selectivity to color. The color selectivity of Hong Kong giant oyster larvae on a plastic settlement substrate is as follows: black>white>red. Long oyster larvae are more prone to settle on black and gray plastic plates, which indicates that black and gray may be protective colors of the oyster larvae to avoid invasion of natural enemies. Barnacles prefers to settle on the red substrate. Pearl oysters also prefer the dark substrate (black and red) without light reflection and have non-photosensitive behavior. Alteromonascalwellii bacteria attract the oyster larvae by producing a compound participating in melanin synthesis.

At present, the research on the influence of the substrate color on the settlement of marine sessile organism larvae is limited to organic polymer plates such as plastic plates and polyethylene plates, asbestos plates and the like. The concrete is one of the most potential substitute substrate and is particularly used for the current oyster reef restoration, the construction of artificial ecological engineering and the corrosion prevention of marine reinforced concrete, relevant information of the influence of its color on the settlement amount of sessile organism larvae has not been found.

### V. Influence of Roughness on Settlement of Marine Sessile Organism Larvae

Generally, the roughness of the surface of the settlement substrate has certain influence on settlement of oyster and barnacle larvae. Researchers at home and abroad have shown that under the same conditions, the oyster and barnacle larvae settled on a rough surface are more than those settled on a smooth surface. The rough surface provides better tactile stimulation for oyster and barnacle larvae to crawl and settle so as to assist the larvae to stay on the substrate; existing cracks and pits can protect the larvae from being invaded by predators; compared with the smooth surface, the rough surface has a larger area and a potential richer and more diversified microbial environment. New research shows that the marine organisms settled on the concrete surface with textures are more than those settled on the smooth surface, and the concrete with textures can promote the settlement and metamorphosis of the larvae. However, some researches show that the roughness has no significant influence on settlement and metamorphosis of the larvae.

In conclusion, although the abovementioned researches have been carried out at present, such as the research on the influence of different substrates as well as color and roughness on the settlement of the marine sessile organisms, the research on the influence of mixing calcium materials into concrete on the settlement of marine sessile organisms has recently been carried out. However, these researches involve in knowledge of related disciplines such as marine organisms, marine microorganisms, marine chemistry and marine concrete engineering materials and structures, these disciplines are very different, so there are more problems encountered in cross research, for example, the problems that the water-cement ratio of the abovementioned cement-based material is not clear, the mechanism of the calcium carbonate material to induce the oyster to settle is not clear, the durability of concrete is seriously insufficient due to excessive calcium powder mixed into cement, and the concrete with excessive bovine bone powder mixed is prone to get mildew; in addition, professional technicians of the marine concrete engineering materials and structures lack professional knowledge of settlement of marine sessile organisms. Therefore, multidisciplinary professional and technical personnel are required to cooperate in order to solve these problems.

### SUMMARY

The present disclosure provides a concrete oyster settlement substrate which can induce sessile organisms to rapidly and compactly settle on a concrete surface and has good durability, aiming to solve the problems that a current concrete settlement substrate for oyster contains a large amount of cement, and water consumption control and curing are not carried out, thus the permeability of concrete is increased, the settlement substrate contains a large amount of alkali, and the alkali is continuously released at a high rate, then the alkalinity of seawater making contact with the settlement substrate is increased, settlement of marine sessile organism larvae is restrained, and meanwhile, due to the fact that a large amount of shell powder is added, the color of the concrete settlement substrate becomes light from dark gray, and settlement of oysters is not facilitated.

The objective of the present disclosure is realized as follows: the cement dosage in the settlement substrate is reduced, a proper cement type is selected, and a proper mineral admixture is added to obtain cement with lower alkalinity. The addition of a dark pigment, biological calcium powder and carbonate (or bicarbonate) and CO₂ curing can further reduce the alkalinity of concrete and improve the calcium carbonate content on the surface of concrete, and promote the early settlement, metamorphosis and later growth of oyster larvae. Meanwhile, the configuration design of the settlement substrate is carried out. In addition, the settlement substrate can be directly used for sessile organism larvae in the culture pond and does not need to be placed in seawater for a long time. Under the condition of no violent collision or smashing, the expected service life of the settlement substrate can be at least 50 years.

The Present Disclosure Further Comprises the Following Structural Characteristics:

The material 1 comprises the following components in percentage by weight:9.0-17.0% of Portland cement, 4.0-11.5% of a mineral admixture, 38.4-47.8% of coarse aggregate, 24.9-37.3% of sand, 6.2-9.0% of water, 0.3-2.0% of a dark pigment, 0.3-2.0% of biological calcium powder, 0.3-1.5% of carbonate (or bicarbonate), and 0.02-0.1% of a super plasticizer.

### BRIEF DESCRIPTION OF DRAWINGS

FIG. 1 shows mildewing condition on a surface of different concrete mix with 10% bovine bone powder (under standard curing);

FIG. 2 shows different concrete mix adding 10% modified bovine bone powder with a fineness larger than 200 meshes;

FIG. 3 is a picture of 210 d of a settlement experiment in sea;

FIG. 4 shows a settlement experiment of 300 d in sea;

FIG. 5 is a picture of a concrete settlement substrate for oyster;

FIG. 6 is a picture of a concrete settlement substrate for oyster;

FIG. 7 is a picture of a concrete settlement substrate for oyster;

FIG. 8 is a picture of 300 d of a settlement experiment in sea.

### DETAILED DESCRIPTION OF EMBODIMENTS

The present disclosure would be described in further detail below with reference to the accompanying drawings and specific examples.

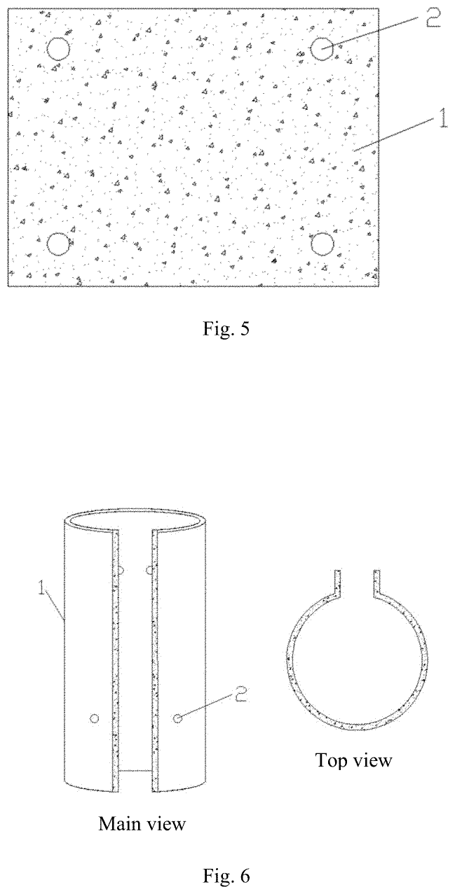

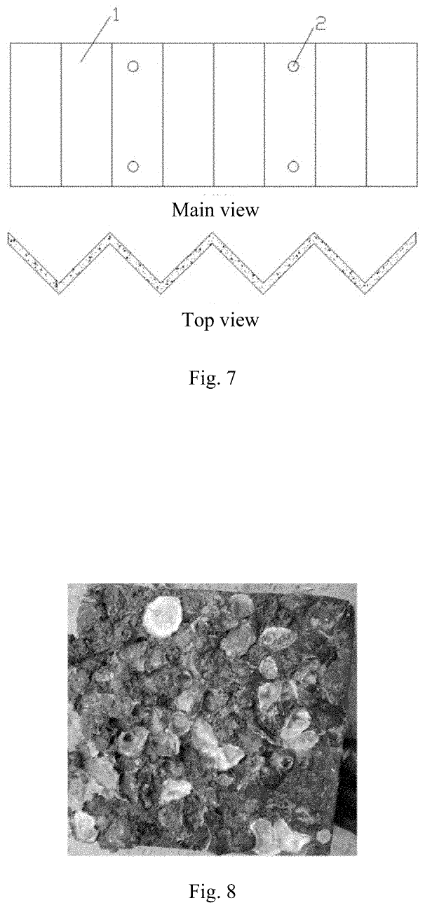

These examples were only used to illustrate the present disclosure and did not limit the scope of the present disclosure. Examples 1 to 21 had the same implementation methods. The shapes of concrete oyster settlement substrates are designed, as shown in FIG. 5-7, and the concrete mix proportion are as follows:

Example 1: the mix ratios by weight of ordinary Portland cement, crushed stone, sand, water and polycarboxylate super plasticizer powder were: 17.1%, 46.67%, 29.0%, 7.2%, 0.03% in a sequence.

Wherein the coarse aggregate was crushed stone with the maximum particle size less than 20 mm, and the crushed stone could be one or more of basalt, granite and diabase crushed stones, which are well graded. The sand could be one or more of river sand, machine-made sand (the parent rock could be basalt or granite), and sea sand, with a particle size of 0.16-5.0 mm. The water should meet the concrete water standard (JGJ63-2006), the Cl− content was less than 1,000 mg/L, the pH value was more than 4.5, and the influence on the initial setting time, final setting time, strength and permeability of cement was small. In the Examples 1 to 20, the above materials were the same.

Example 2: According to the reference concrete mix, the mix ratio by weight of ordinary Portland cement, silica fume, blast furnace slag powder, crushed stone, sand, water and polycarboxylate super plasticizer powder were 10.26%, 0.86%, 5.98%, 46.67%, 29.0%, 7.2%, and 0.03% in a sequence.

| | Proportion in mass | | | Rate of change relative | |
|---|---|---|---|---|---|
| | of concrete | | | to reference group | |
| | Portland | Slag | Silica | Electric | settlement rate of |
| Group | cement | powder | fume | flux | oyster larvae |
| Example 1 | 17.1% | 0% | 0% | 40% | −31% |
| Example 2 | 10.26% | 5.98% | 0.86% | 0% | 0% |

The above examples showed that the blast furnace slag powder and the silica fume were doped into concrete, voids among particles such as cement could be filled, a pozzolanic reaction could be generated, micro structure of interface transition zone was improved, therefore, the basic strength of the concrete was guaranteed, and the alkalinity and permeability of the concrete were reduced. The alkalinity difference between the concrete and seawater in contact with the concrete was reduced, the alkali release rate could be controlled through the low permeability, and finally oyster larvae could be settled to the surface of the concrete more easily.

Example 3: The mix ratios by weight of the unmodified dark pigment, the ordinary Portland cement, the silica fume, the blast furnace slag powder, the crushed stone, the sand, the water and the polycarboxylate super plasticizer powder were 0.51%, 10.26%, 0.79%, 5.54%, 46.67%, 29.0%, 7.2% and 0.03% in sequence.

Example 4: The mix ratios by weight of the unmodified dark pigment, the ordinary Portland cement, the silica fume, the blast furnace slag powder, the crushed stone, the sand, the water and the polycarboxylate super plasticizer powder were 0.86%, 10.26%, 0.75%, 5.23%, 46.67%, 29.0%, 7.2% and 0.03% in sequence.

Example 5: The mix ratios by weight of the unmodified dark pigment, the ordinary Portland cement, the silica fume, the blast furnace slag powder, the crushed stone, the sand, the water and the polycarboxylate super plasticizer powder were 1.37%, 10.26%, 0.68%, 4.79%, 46.67%, 29.0%, 7.2% and 0.03% in sequence.

Example 6: The mix ratios by weight of the modified dark pigment (the mass ratio of iron oxide black to the aniline black mixture was 1:1), the ordinary Portland cement, the silica fume, the blast furnace slag powder, the crushed stone, the sand, the water and the polycarboxylate super plasticizer powder were 0.51%, 10.26%, 0.79%, 5.54%, 46.67%, 29.0%, 7.2% and 0.03% in a sequence.

Example 7: The mix ratios by weight of the modified dark pigment (the mass ratio of iron oxide black to the aniline black mixture was 1:1), the ordinary Portland cement, the silica fume, the blast furnace slag powder, the crushed stone, the sand, the water and the polycarboxylate super plasticizer powder were 0.86%, 10.26%, 0.75%, 5.23%, 46.67%, 29.0%, 7.2% and 0.03% in a sequence.

Example 8: The mix ratios by weight of the modified dark pigment (the mass ratio of iron oxide black to the aniline black mixture was 1:1), the ordinary Portland cement, the silica fume, the blast furnace slag powder, the crushed stone, the sand, the water and the polycarboxylate super plasticizer powder were 1.37%, 10.26%, 0.68%, 4.79%, 46.67%, 29.0%, 7.2% and 0.03% in a sequence.

The modification method of modified dark pigment was as follows: mixing 196 transparent resin, 3% of a hardener and 1.5% of an accelerator, wherein the volume ratio of the pigment to the resin was 1:0.2, curing at a normal temperature for 4 h, curing at 60° C. for 4 h, breaking, and grinding with a vibration mill until the fineness was greater than 400 meshes.

| | | | | | Rate of change | |
|---|---|---|---|---|---|---|
| | | | | | relative to | |
| | Proportion in mass of concrete | | | | | settle- |
| | un- | | | | | ment |
| | modified | modified | | | Elec- | rate of |
| | dark | dark | Slag | Silica | tric | oyster |
| Group | pigment | pigment | powder | fume | flux | larvae |
| Example 3 | 0.51% | | 5.54% | 0.79% | 0.4% | 21% |
| Example 4 | 0.86% | | 5.23% | 0.75% | 21% | 38% |
| Example 5 | 1.37% | | 4.79% | 0.68% | 34% | 32% |
| Example 6 | | 0.51% | 5.54% | 0.79% | −1.6% | 27% |
| Example 7 | | 0.86% | 5.23% | 0.75% | 0.5% | 47% |
| Example 8 | | 1.37% | 4.79% | 0.68% | 3.2% | 53% |

The dark pigment had great influence on permeability of concrete, and the settlement amount of the oyster larvae was reduced along with increase of the dosage. On one hand, due to the fact that the permeability of the concrete was increased, leach of alkali of the concrete was increased; on the other hand, iron oxide in the concrete was possibly converted into iron ions, so that the concentration of the iron ions was increased, and settlement of the oyster larvae was inhibited. In order to solve the problems, after the pigment was coated with resin, the pigment was ground into powder, thus the permeability resistance of the concrete could be greatly improved, and particularly when the dosage was 1.37%, the electric flux of the concrete was only increased by 3.2%. Meanwhile, along with increase of the dark pigment, the settlement of the oysters was continuously increased, it was different from the situation that the dosage was 1.37% before modification, the settlement ratio of the oyster larvae was reduced.

Example 9: The mix ratios by weight of the unmodified bovine bone powder, the ordinary Portland cement, the silica fume, the blast furnace slag powder, the crushed stone, the sand, the water and the polycarboxylate super plasticizer powder were 0.51%, 10.26%, 0.79%, 5.54%, 46.67%, 29.0%, 7.2% and 0.03% in a sequence.

Example 10: The mix ratios by weight of the unmodified bovine bone powder, the ordinary Portland cement, the silica fume, the blast furnace slag powder, the crushed stone, the sand, the water and the polycarboxylate super plasticizer powder were 0.86%, 10.26%, 0.75%, 5.23%, 46.67%, 29.0%, 7.2% and 0.03% in a sequence.

Example 11: The mix ratios by weight of the unmodified bovine bone powder, the ordinary Portland cement, the silica fume, the blast furnace slag powder, the crushed stone, the sand, the water and the polycarboxylate super plasticizer powder were 1.37%, 10.26%, 0.68%, 4.79%, 46.67%, 29.0%, 7.2% and 0.03% in a sequence.

Example 12: The mix ratios by weight of the modified bovine bone powder, the ordinary Portland cement, the silica fume, the blast furnace slag powder, the crushed stone, the sand, the water and the polycarboxylate super plasticizer powder were 0.51%, 10.26%, 0.79%, 5.54%, 46.67%, 29.0%, 7.2% and 0.03% in a sequence.

Example 13: The mix ratios by weight of the modified bovine bone powder, the ordinary Portland cement, the silica fume, the blast furnace slag powder, the crushed stone, the sand, the water and the polycarboxylate super plasticizer powder were 0.86%, 10.26%, 0.75%, 5.23%, 46.67%, 29.0%, 7.2% and 0.03% in a sequence.

Example 14: The mix ratios by weight of the modified bovine bone powder, the ordinary Portland cement, the silica fume, the blast furnace slag powder, the crushed stone, the sand, the water and the polycarboxylate super plasticizer powder were 1.37%, 10.26%, 0.68%, 4.79%, 46.67%, 29.0%, 7.2% and 0.03% in a sequence.

The modification method of bovine bone powder was as follows: 100-mesh bovine bone powder was added into a phosphoric acid solution with a concentration of 2%, and the weight ratio of the bovine bone powder to the phosphoric acid solution was 1:3. The bovine bone powder and the phosphoric acid solution were mixed in a stirrer at a rotating speed of 200-500 rpm for 30 min under temperature of 20-30° C., and then were centrifuged for 3 min by a centrifugal machine at a rotating speed of 3,000-5,000 rpm. The supernatant was poured, and the centrifuged solid substance was washed for 2-3 times by using water until washing water did not show acidity anymore; and vacuum drying was performed on the centrifuged solid substance at the temperature of 40° C., the dried bovine bone powder and slag powder in a ratio of 1:4 were ground by using a vibration mill until the fineness was more than 200 meshes for later use.

| | Proportion in mass | | | | Rate of change | |
|---|---|---|---|---|---|---|
| | of concrete | | | | relative to | |
| | un- | modi- | | | | settle- |
| | modi- | fied | | | | ment |
| | fied | bovine | Slag | | Elec- | rate of |
| | bovine | bone | pow- | Silica | tric | oyster |
| Group | bone | powder | der | fume | flux | larvae |
| Example 9 | 0.51% | | 5.54% | 0.79% | 20% | 90% |
| Example 10 | 0.86% | | 5.23% | 0.75% | 42% | 145% |
| Example 11 | 1.37% | | 4.79% | 0.68% | 57% | 205% |
| Example 12 | | 0.51% | 5.54% | 0.79% | −0.5% | 117% |
| Example 13 | | 0.86% | 5.23% | 0.75% | 2.1% | 233% |
| Example 14 | | 1.37% | 4.79% | 0.68% | 4.2% | 400% |

Note:
The modified bovine bone powder was ground until the fineness was 200 meshes to 300 meshes.

Because the grinding difficulty of bovine bone powder was high, and the bovine bone powder was difficultly continuously ground when the granularity was about 100 meshes, the bovine bone powder of 100 meshes was chemically modified by diluted phosphoric acid with a concentration of 2%, and then the dried bovine bone powder and slag powder in a ratio of 1:4 were ground by using the vibration mill until the fineness was more than 200 meshes. Therefore, the contact of the modified bovine bone powder and alkaline substances in the concrete was increased, and meanwhile, the micro structure in the concrete was more compact, and the previous mildew phenomenon was avoided. After modification, the penetration resistance of the concrete was improved under the condition of low dosage. Even if the dosage reached 1.37%, the electric flux was increased by only 4.2%, and the settlement change rate of oyster larvae was increased from 205% to 400%.

Example 15: The mix ratios by weight of the modified dark pigment (the mass ratio of iron oxide black to the aniline black mixture was 1:1), modified bovine bone powder, the ordinary Portland cement, the silica fume, the blast furnace slag powder, the crushed stone, the sand, the water and the polycarboxylate super plasticizer powder were 0.86%, 0.51%, 10.26%, 0.68%, 40.79%, 46.67%, 29.0%, 7.2%, 0.03% in a sequence.

Example 16: The mix ratios by weight of the modified dark pigment (the mass ratio of iron oxide black to the aniline black mixture was 1:1), modified bovine bone powder, the ordinary Portland cement, the silica fume, the blast furnace slag powder, the crushed stone, the sand, the water and the polycarboxylate super plasticizer powder were 0.86%, 0.86%, 10.26%, 0.64%, 4.48%, 46.67%, 29.0%, 7.2%, 0.03%.

Example 17: The mix ratios by weight of the modified dark pigment (the mass ratio of iron oxide black to the aniline black mixture was 1:1), modified bovine bone powder, the ordinary Portland cement, the silica fume, the blast furnace slag powder, the crushed stone, the sand, the water and the polycarboxylate super plasticizer powder were 0.86%, 1.37%, 10.26%, 0.58%, 4.03%, 46.67%, 29.0%, 7.2%, 0.03% in a sequence.

| | Proportion in | | | | Rate of change | |
|---|---|---|---|---|---|---|
| | mass of concrete | | | | relative to | |
| | modi- | | | | | settle- |
| | fied | modified | | | | ment |
| | dark | bovine | | | Elec- | rate of |
| | pig- | bone | Slag | Silica | tric | oyster |
| Group | ment | powder | powder | fume | flux | larvae |
| Example 15 | 0.86% | 0.51% | 0.68% | 4.79% | −0.5% | 167% |
| Example 16 | 0.86% | 0.86% | 0.64% | 4.48% | 1.1% | 300% |
| Example 17 | 0.86% | 1.37% | 0.58% | 4.03% | 4.2% | 500% |

Compared with the reference group, under the condition that the mixing amount of the modified dark pigments was 0.86%, the mixing amount of modified bovine bone powder was 0.51%, 0.86% and 1.37% respectively, and the settlement amount of oyster larvae was increased by 167%, 300% and 500% respectively. Besides, compared with single-mixed modified bovine bone powder, under the condition that the mixing amount of the modified dark pigments was 0.86%, the change rate of the oyster larvae was increased by 10%. It reflected the synergistic effect of the two inducers.

Example 18: The mix ratios by weight of the modified dark pigment (the mass ratio of iron oxide black to the aniline black mixture was 1:1), the ordinary Portland cement, the silica fume, the blast furnace slag powder, the crushed stone, the sand, the water, the sodium carbonate and the polycarboxylate super plasticizer powder were 0.86%, 10.26%, 0.71%, 4.79%, 46.67%, 29.0%, 7.2%, 0.3%, 0.03% in a sequence.

Example 19: The mix ratios by weight of the modified dark pigment (the mass ratio of iron oxide black to the aniline black mixture was 1:1), the ordinary Portland cement, the silica fume, the blast furnace slag powder, the crushed stone, the sand, the water, the sodium carbonate and the polycarboxylate super plasticizer powder were 0.86%, 10.26%, 0.65%, 4.58%, 46.67%, 29.0%, 7.2%, 0.8%, 0.03% in a sequence.

The modification method of sodium carbonate was as follows: diatomite with SiO₂ content >90% and fineness of 600 mesh was selected, 100 g of sodium carbonate was added to 100 g water at room temperature and stirred until it was completely dissolved and ready for use; then, 150 g of the above diatomite was added to the solution, stirred in a stirrer with a rotating speed of 200-500 rpm for 30 min, and then dried in a drying oven with a drying temperature of 100° C.

| | Proportion in mass | | | | Rate of change | |
|---|---|---|---|---|---|---|
| | of concrete | | | | relative to | |
| | Modi- | | | | | settlement |
| | fied | | | | Elec- | rate of |
| | dark | Sodium | Slag | Silica | tric | oyster |
| Group | pigment | carbonate | powder | fume | flux | larvae |
| Example 18 | 0.86% | 0.3% | 0.71% | 4.97% | 2.3% | 75% |
| Example 19 | 0.86% | 0.8% | 0.65% | 4.58% | 4.6% | 116% |

According to the example, the dark pigment and sodium carbonate were compounded and mixed to realize a dark concrete surface, which met the light-shielding requirement of oyster eyespot larvae and provided synthesis of calcium carbonate for settlement and metamorphosis of the oyster larvae; the settlement rate of the oyster larvae could be increased by compounding mixing; and when the ratio of the dark pigment was 0.86%, and the ratio of sodium carbonate was 0.8%, the settlement rate was increased by 116%. It is proved that carbonate (bicarbonate) could promote induced settlement of the oyster larvae.

Example 20: The mix ratios by weight of the modified dark pigment (the mass ratio of iron oxide black to the aniline black mixture was 1:1), the biological calcium powder, the ordinary Portland cement, the silica fume, the blast furnace slag powder, the crushed stone, the sand, the water, the sodium carbonate and the polycarboxylate super plasticizer powder were 0.86%, 0.86%, 10.26%, 0.54%, 3.78%, 46.67%, 29.0%, 7.2%, 0.8%, 0.03% in a sequence.

According to the example, the dark color pigment, biological calcium powder and sodium carbonate were compounded and mixed, thus on the premise that there was no significant influence on the basic property of concrete, the dark color concrete surface could be provided to meet the light-shielding requirement of oyster eyespot larvae, and nutrient substances for synthesis of calcium carbonate during settlement and metamorphosis of the oyster larvae could be provided, and therefore, the settlement rate of the oyster larvae was increased.

The implementation method of the Examples 1-20 comprised the following specific operation steps:

Three disc samples with size of (100×50 mm and five plate samples with the diameter of 200×200×30 mm were prepared according to the above preparation method of a Portland cement concrete settlement substrate for oyster, and were used for respectively testing the chloride ion penetration resistance of the concrete for 28 d and the settlement and metamorphosis conditions of oyster larvae in a laboratory after standard curing for 28 d. The specific operation steps were as follows:

### (I) Molding of Samples

1, Ordinary Portland cement, mineral admixture, crushed stone, sand, water, dark pigment, biological calcium powder, carbonate (or bicarbonate) and polycarboxylate super plasticizer powder were accurately weighed according to the above mass;

2, Abrasive paper with different surface roughness (including 20 meshes, 60 meshes and 200 meshes) were stuck in molds of the plate samples of concrete for later use;

3, The crushed stone and the sand were put into a concrete mixer for mixing for 0.5-1 min; then the ordinary Portland cement, the mineral admixture, the biological calcium powder, the carbonate (or bicarbonate) and the dark pigment were added and continuously mixed for 0.5-1 min; the water and the super plasticizer were added and mixed for 2-6 min; after obtaining desired homogeneity mixing, casting, consolidating and demolding were performed to obtain three disc samples with the size of (D100×50 mm and five plate samples with the size of 200×200×30 mm;

4, The demolded concrete samples were immediately put into a CO₂ curing chamber with 10 atmospheric pressures for curing for 2 h to reduce the alkalinity of the concrete samples, and standard curing was performed for 28 d; corresponding permeability evaluation was performed at each age, and oyster larva settlement and metamorphosis experiments were performed in a laboratory after 28 d.

### (II) Specific Steps of a Rapid Chloride Ion Penetration Experiment:

According to “Standard Test for Electrical Indication of Concrete's Ability to Resist Chloride Ion Penetration” (ASTM1202-2017), when standard curing was carried out for 28 d, three disc samples with the diameter of <D100×50 mm were taken out from a curing chamber respectively, water and impurities on the surfaces of the disc samples were cleaned, and after the surfaces of the disc samples were dried, and the side surfaces of the disc samples were coated with a thin layer of epoxy resin. Then the samples were put into a vacuum water saturation machine for 20-24 h. The samples were taken out, the surfaces of the samples were cleaned, and the samples were put into polymethyl methacrylate molds, and after the sealing property between the samples and the molds was detected, a sodium chloride solution (an electrode was connected with a negative electrode of a power supply) with the mass concentration of 3% and a sodium hydroxide solution (an electrode was connected with a positive electrode of the power supply) with the molar concentration of 0.3 mol/L were respectively placed into the molds on the two sides. An experimental instrument was started, experimental data were recorded after 6 h, and the operations were repeated on the two subsequent samples. Finally, electric flux calculation was carried out according to specifications.

### (III) Specific Step of an Indoor Settlement and Metamorphosis Experiment of Oyster Larvae

After standard curing was carried out for 28 d, plate samples with the sizes of 200×200×30 mm were taken out from the curing room respectively, and water and impurities on the surfaces of the samples were cleaned; then the samples were put into a test pool, and the test pool (2.8 m×1.7 m×1 m) was prepared in a laboratory, wherein the abundance of the oyster larvae was 0.85 ind/ml3, seawater in the pool was sand-filtered Huang Hai seawater, and the salinity was about 32-34%; after the water level of the seawater was higher than that of the concrete samples, oxygen pipes were uniformly distributed into the test pool, and the oyster larvae were prepared to be put into the test pool. After the oyster larvae were slowly and uniformly mixed in a water bucket, the mass of the seawater containing the oyster larvae was accurately weighed by using a beaker, and then the seawater was uniformly distributed into the test pool.

After an oyster settlement induction test was started, seawater in the test pool was replaced every day, the water replacement amount was ⅓ of the total capacity of the test pool, a sieve (larger than or equal to 200 meshes) was used for blocking a water outlet, non-settled oyster larvae were prevented from being lost along with water, the larvae on the sieve were put into the test pool again, chlorella was fed regularly and quantitatively through a rubber head dropper at 9 a.m. and 7 p.m. every day, and the oyster settlement condition was observed.

After the test continued to the designated age, water in the test pool was drained, the samples were taken out, the number on the surfaces of the samples were counted, recorded and survival rate of the oysters on the surfaces of the samples were analyzed, and the smooth bottom face in concrete casting molding was taken during counting.

Compared with “A novel concrete artificial reef and a preparation method thereof” or CN104529286 A (hereafter, “comparison document 1”), the difference was that:

The objective of the present disclosure was different from that of the comparison document in that: Although oyster shell powder was added into the concrete in the comparison document 1, the objective of the comparison document 1 was to utilize wastes and repair and improve the artificial reef. The objective of the present disclosure was to induce the settlement of the oyster larvae.

Compared with “A bionic concrete artificial reef and a preparation method thereof” or 2015 CN104938384 A (hereafter “comparison document 2”), the difference was that:

(1) The objective of the present disclosure was different from that of the comparison document 2 in that: Although the oyster shells or oyster shell powder was added into the concrete in the comparison document 2, the objective of the comparison document 2 was mainly achieved through the surface bionic property, including fish, microorganisms and algae, the number of the microorganisms was increased, and thus the water environment was improved; and oysters were not mentioned. The objective of the present disclosure was to induce the settlement of the oyster larvae.

(2) The comparison document 2 indicated that the cement replaced by the biological calcium carbonate powder (150-200 meshes) below 10% had no obvious effect on settlement induction. However, the modified bovine bone powder and biological calcium carbonate powder (with the fineness being 100-1,000 meshes) were adopted in the research process of the present disclosure, and the optimal dosage of the bovine bone powder and the biological calcium carbonate powder accounted for less than 10% of the cementitious material.

(3) The bovine bone powder and the biological calcium carbonate powder were modified and were specifically modified by treating the 100-500-mesh egg shell powder, coral powder, oyster shell powder and fishbone powder with one or two of acetic acid, acetic acid aqueous solution, silicic acid and sulfurous acid, and treating the 100-500-mesh bovine bone powder with one or two of diluted phosphoric acid, sulfuric acid, hydrochloric acid and nitric acid.

(4) Comparison document had difficulty in inlaying oyster shells on the concrete surface, the method was not adopted on each engineering surface, and the feasibility was low. In the present disclosure, the shell powder was added into the concrete to induce the settlement of the sessile organisms, and the dosage of the shell powder accounted for less than 10% of the mass of the cementitious material, the construction was simple, and the settlement amount of the oyster could be greatly increased. And

(5) The phenomenon of serious artificial reef corrosion occurred in the marine environment for many times in recent years, and serious corrosion was mainly caused by the combined action of biological sulfuric acid secreted by anaerobic microorganism thiobacillus and acidic substances secreted by other bacteria. The acid corrosion resistance of calcium carbonate was very weak, so that serious acid corrosion could be caused by too high content of calcium carbonate with relatively high fineness.

Compared with “Effect of the Substrate Types on Oyster Settlement, Growth, Population Establishment and Reef Development” by Fan Ruiliang (hereafter “comparison document 3”), the difference was that:

(1) In the comparison document 3, 80-mesh bovine bone powder, calcium powder and gypsum powder were used and independently added into the concrete. The fineness of all calcium materials in the present disclosure was larger than 100 meshes and was larger than that of the materials in the comparison document 3. Bovine bone powder is also added, but it is mixed with one or more of biological calcium carbonate powder, such as oyster shell powder, egg shell powder, fish bone powder and coral powder. The purpose is to give full play to their inducing ability while considering the particle gradation of concrete.

(2) The bovine bone powder was ground by using a vibration mill under normal temperature conditions, when the fineness was greater than 80 meshes, the bovine bone powder contained lots of collagen and was severely agglomerated and could not be continuously ground. The diluted acid modification technology was adopted in the present disclosure, and the bovine bone powder was compounded with other substances and ground, so that the bovine bone powder with small particle size and modified biological calcium powder with the fineness of more than 200 meshes were obtained. The prepared biological calcium powder remained the original substances of biological calcium, greatly increased the release rate of the substances inducing oyster larvae to settle, and reduced the dosage of the biological calcium powder, thereby reducing the effect on the cement concrete property. And

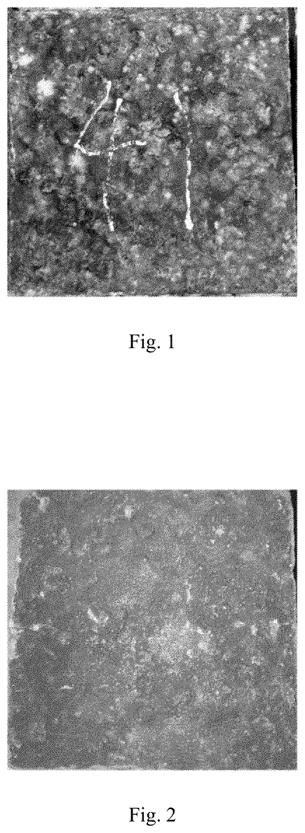

(3) Due to the fact that bovine bone powder contained rich organic substances such as collagen, the strength and the penetration resistance of concrete could be reduced when a large amount of the substances were added, especially after the dosage exceeded 5%, the strength of the concrete was rapidly reduced, the penetration resistance was remarkably reduced, and mildew could grow on the surface of the concrete under the standard curing condition. FIG. 1 showed the mildewing condition of the concrete samples. FIG. 2 showed the surface condition of the modified concrete.

As shown in FIG. 1, mildew on the surface of concrete was white flocculent and almost covered the whole surface of the concrete; under the same bovine bone powder dosage, age and curing conditions, the surface of the concrete in FIG. 2 was not mildewed.

In the present disclosure, a diluted acid modification control technology and a composite grinding technology are adopted in a control way, the induction capability of the bovine bone powder is fully exerted, the dosage of the bovine bone powder is greatly reduced, and anti-corrosion treatment and modification are carried out, so that a composite inducer taking the bovine bone powder as a main component is realized, the dosage of the composite inducer is small, the strength and permeability of concrete are hardly influenced, meanwhile, the composite inducer has very strong oyster larva settlement capability, and the problem of mildewing of the concrete is solved. Compared with concrete without the inducer, the concrete with the inducer enables the number of settled oyster larvae to be obviously increased.

The comparison documents and consulted literature data showed that the calcium content was very important for the settlement of the oyster larvae, and some experimental results at present also proved that the settlement and the growth of the oyster larvae could be promoted by adding a proper dosage of calcium carbonate substances into a cement-based material. However, cement concrete contained a large number of calcium ions, the pH value in a pore solution was generally greater than 12.5, and the pH value of a saturated calcium hydroxide solution was about 12 at normal temperature, thus the concentration of the calcium ions in the pore solution of the concrete was about 5 mmol/L; and the solubility of calcium carbonate was very small and was only 9.5×10−5 mol/L (9.5×10−2 mmol/L) at 25° C. At present, the optimal range of the concentration of the calcium ions for inducing the settlement of the oysters was 10-25 mmol/L, and even if the oyster larvae were placed in the saturated calcium carbonate solution, the concentration of Ca²⁺ was not enough to provide the appropriate ion concentration for the settlement of the oysters. Further, Ca(OH)₂ in the cement concrete could be released more quickly, and the dissolution of the calcium carbonate needed a longer time. Therefore, it could be understood or inferred that the calcium carbonate material added into the concrete could promote the settlement of the oyster larvae, and the Ca²⁺ did not play a leading role. The early settlement and metamorphosis of the oysters were related to HCO₃₋, and the secondary shells of the calcium carbonate were generated by HCO₃₋ together with the Ca²⁺ during metamorphosis. After the calcium carbonate was added, the calcium carbonate reacted with CO₂ and water to generate Ca(HCO₃)₂ to participate in the settlement, which was a fundamental mechanism for promoting the settlement of the oyster larvae.

There was an optimum dosage in the dosage of calcium carbonate in the cement-based material, which could be explained from the following three aspects:

1) For equivalent substituted cement, the alkali in the concrete was diluted along with the increase of the dosage of the calcium carbonate, and the total alkalinity was reduced; however, along with the increase of the dosage of the calcium carbonate, the dissolution probability of the calcium carbonate in the concrete was increased, and the content of HCO₃₋ in the solution was increased, thus the settlement and the metamorphosis of the oysters were promoted; however, when the dosage was too large, the permeability of the concrete was increased sharply, and the alkali and carbonate radicals in the concrete were quickly leached, so that the negative effect of the alkali was prominent, and the critical or negative effect of the carbonate radicals was initially prominent, thus the settlement amount was reduced;

2) For equivalent substituted aggregate, the permeability of the concrete was reduced along with the increase of the dosage, consequently, the leach of calcium ions and OH− was reduced, but the leach rate of carbonate ions was gradually increased first, and when the leach rate reached a certain value, oyster settlement reached a maximum value; and along with the continuous increase of the dosage, the reduction amplitude of the calcium ions was large, and the carbonate radicals were possibly reduced, thus the settlement of the oyster larvae was limited by the concentration of the calcium ions, and the settlement was reduced; and

3) For equivalent substituted mineral admixture, the permeability was increased along with the increase of the dosage, and a proper HCO₃₋ concentration range suit for the oyster settlement was obtained due to the increase of calcium carbonate, which indicated the increase of the settled oyster larvae; and along with the continuous increase of the dosage of the mineral admixture, the dosage of the mineral admixture was reduced, so the amount of leaching alkali was increased, the carbonate radicals were increased, and the settlement of the oyster larvae was inhibited by excessive alkali and HCO₃₋ ions.

Compared with “Study on the Organisms Settlement of Artificial Reefs Constructed with Five Different Cements” by Li Zhenzhen, Gong Pihai, Guan Changtao, et al. Progress in Fishery Sciences, 2017, 38(5):57-63, (hereafter, “comparison document 4”), the difference was that:

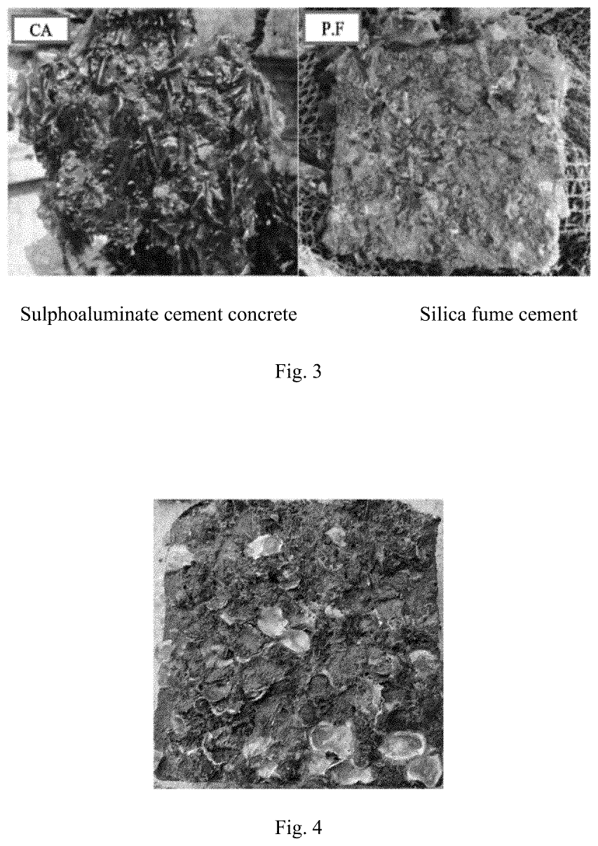

In the comparison document 4, the concrete was used for enriching marine organisms, focusing on the amount and diversity of settled biomass, and the mainly settled organisms were various algae and the like. The research objective of the present disclosure was to induce the settlement of the oysters, but the alkalinity tolerance of oysters and barnacles was higher than that of algae, and a large amount of calcium ions were needed for settlement and metamorphosis of the oysters, so that the two kinds of concrete looked like the same, but in fact there was a big difference. FIG. 3 and FIG. 4 respectively showed the oyster settlement comparison conditions between the comparison document 4 after performing the real sea settlement experiment for about 210 d and the present disclosure after performing the real sea settlement experiment for 300 d.

In the comparison document 4, composite Portland cement, slag Portland cement, pozzolanic Portland cement, fly ash Portland cement and aluminate cement were used. In the present disclosure, low-alkalinity cement was achieved by ordinary Portland cement adding mineral admixtures; silica fume was one of the mineral admixtures and had high activity, and optimum dosage of silica fume could achieve obvious effect on increasing the durability of reinforced concrete in the marine environment. Low-alkalinity cement with the excellent strength and durability could be obtained through optimization design and experiments. Meanwhile, by means of the high penetration resistance characteristic of the silica fume concrete, even if the alkalinity in the concrete was high, a large number of oyster larvae still settled to, metamorphosized and grew on the concrete surface. The low-alkalinity sulphoaluminate cement was compounded to regulate and control the alkalinity of the cement concrete, and thus an appropriate pH value was provided for oyster larva settlement. In addition, compared to marine plants, oysters, barnacles and other sessile organisms were different in alkali resistance, the environments needed in the settlement period and later period were different, for example, a large number of calcium ions were needed for settlement, metamorphosis and later-period growth of the barnacles and the oysters.

Therefore, the part of knowledge related to crossing of the marine sessile organism discipline, marine plants and marine concrete engineering disciplines, and technicians in the fields of concrete and engineering or the field of marine organisms could not obtain the technical characteristics of close correlation between the balance between the reduction of the alkalinity of the concrete and the concentration of calcium ions and settlement of the marine sessile organisms from the comparison document 4.

### Dark Pigment

In addition, the present disclosure has the unique characteristics and the following beneficial effects:

The light-shielding characteristic of oyster eyespot larvae was utilized, the dark pigment (one or two of iron oxide black, nigrosine, carbon black, antimony sulfide, iron oxide red and organic pigment red) was modified and doped into the concrete, the color of the concrete was changed and darkened, the concrete was regarded as a dark environment by the oyster larvae, thus the oyster larvae were induced to reach the dark concrete surface, the contact probability of the larvae and the concrete surface were increased, and the induced settlement rate of the oyster larvae was increased. Specifically: Marine organism researchers carried out the research on the settlement of marine sessile organisms by substrates with different colors in order to cultivation and propagation or eliminate unexpected populations, which belonged to the marine organism discipline. The marine organism discipline was quite different from the marine concrete engineering or concrete material discipline, they were completely two major disciplines. Through the crossing of the marine sessile organism discipline and the concrete discipline, the induced settlement of the oyster larvae by dark concrete was realized. In the present disclosure, the dark pigment was added to deepen the surface color of concrete so as to promote the settlement of the oyster larvae. Other materials were added in the concrete, which could affect the properties of the concrete. In the present disclosure, in consideration of the concrete of different cements, there was a difference in surface color of the concrete. Therefore, the dosage of the dark substances could be determined according to the type and dosage of the cement. The dark pigment also affected the properties of the concrete. Most importantly, when the dark pigment was added, if the penetration rates of alkali, Ca2+ and the like in the concrete were not controlled, the leached alkali could affect the settlement, metamorphosis and growth of the sessile organism larvae, and when the dosage was greater than a certain value, the settlement amount of the larvae was reduced. In the present disclosure, the penetration resistance of the concrete was designed and controlled, and the main measures were as follows: selection of the type of the dark pigment, control of the dosage and modification. With the increase of the dosage of the dark pigment, the settlement rate of the larvae was increased first, and when the dosage accounted of 0.5-6% of the cementitious material, the settlement amount of the larvae was maximum, but was slightly increased or kept unchanged later.

### Carbonate (Bicarbonate)

According to the research of the inventor, the main action mechanism of adding the calcium carbonate substances into the cement-based material to induce oyster to settle was that CO₃²⁻, rather than Ca²⁺, played a main role in settlement and metamorphosis of oyster larva, so the present disclosure innovatively proposed to induce oyster larvae to settle on the surface of concrete by carbonate and bicarbonate which were not calcium carbonate. Therefore, carbonate (bicarbonate) (sodium carbonate, potassium carbonate, calcium bicarbonate, sodium bicarbonate and potassium bicarbonate) were mixed into the concrete, and the strength and impermeability of the concrete were basically kept unchanged through modification, and as a result, the induced settlement rate of the oyster larva was greatly increased. Specifically:

Marine organism researchers carried out the research on different ions on the settlement and metamorphosis of marine sessile organisms in order to clarify oyster settlement mechanisms and cultivation propagation, which belonged to the marine organism discipline. The marine organism discipline was quite different from the marine concrete engineering or concrete material discipline, they were completely two major disciplines. Through the crossing of the marine sessile organism discipline and the concrete discipline, corresponding substances were added into the concrete to induce the oyster larvae to settle on the surface of the concrete. Soluble salts had great influence on the properties of the concrete, such as influence on early workability, setting time and later strength and penetration resistance. Diatomite was adopted as a carrier in the present disclosure, the salts were fixed in the diatomite, and thus the influence of the soluble salts on the properties of the concrete was reduced. Meanwhile, the effect of improving the properties of the concrete by the diatomite was utilized to keep good mechanical property and penetration resistance of the concrete when these inducing substances were added. In addition, diatomite serving as the carrier had a slow release effect, thus soluble salt was released slowly, and particularly, the release was kept at a very low rate after the diatomite was soaked in seawater for a certain period of time. When the mass of sodium carbonate added alone was 0.8%, the induction efficiency increased the most, reaching 66%. Therefore, the above knowledge related to crossing of the marine sessile organism discipline, chemistry and marine concrete engineering disciplines, and technicians in the fields of concrete and engineering or the field of marine organisms could not obtain the technical characteristics of close correlation between the technology of doping the carbonate (bicarbonate) into the concrete to change the ion content of the carbonate (bicarbonate) on the surface of the concrete and control the permeability of the concrete and the concrete with the capability of efficiently inducing the settlement of the oysters through the existing background.

### Concrete Permeability

The strength and permeability of concrete were two main properties of the concrete. Different inducers added into reference concrete could influence the properties of the concrete. Therefore, when different substances were added to promote settlement, metamorphosis and later growth of the oyster larvae, it must be integrally controlled to make sure that the different substances did not have a big impact on the strength and permeability of the concrete, and then raw materials were selected according to the compatibility of various raw materials. If the properties of the raw materials could not meet the actual requirements, the raw materials were modified and then added so as to achieve the expected functions. In practice, although related research was performed by considering the influence of the dosage of calcium on oyster larva settlement, the properties of concrete, the water-cement ratio, the dosage of calcium, maintenance and the like were not considered, moreover, the leakage rate of alkali and ions in the concrete could be changed due to the change of the permeability of the concrete, the poorer the penetration resistance of the concrete was, the higher the leakage rate of the alkali and the ions in the concrete was, and the leakage rate might be exponentially increased. Therefore, the leached alkali and ions could greatly influence the larvae, a change from promoting settlement to inhibiting settlement might occur, and particularly when the content of cement was large, the situation was more serious. Therefore, when the inducer was added into the concrete, it must be guaranteed that the change of the penetration resistance of the concrete was within a controllable range, for example, the change could not exceed 10%. In this way, the induction effects could be compared, otherwise, the influence of single inducer addition or inducer composite addition on the induction effect of the oyster larvae could not be evaluated.

Only the optimum environment required by settlement, metamorphosis and later growth of marine sessile organisms was mastered, and concrete could be designed from the penetration resistance level of the concrete instead of only considering the dosage of various raw materials and ignoring the penetration resistance change of the concrete. Therefore, the above knowledge related to crossing of the marine sessile organism discipline, chemistry and marine concrete engineering disciplines. Technicians in the field of concrete, engineering or marine biology cannot obtain the technical characteristics of the present disclosure through the existing background, which relates to the close relationship between the overall control of the penetration resistance of the concrete and the inducer's ability to promote the efficient adhesion of oysters.

### Roughness Gain

The rough surface provided better tactile stimulation and increased the settlement force for the oyster larvae to crawl and settle, and the retention time of the oyster larvae on the substrate was increased; meanwhile, existing cracks and pits could protect the larvae and reduce the invasion probability of preys; compared with a smooth settlement substrate, this settlement substrate had a larger settlement area, so that the increase of the settlement rate of the oyster larvae on the settlement substrate with the rough surface was promoted.

Therefore, the above knowledge related to crossing of the marine sessile organism discipline, marine plants and marine concrete engineering disciplines, and technicians in the fields of concrete and engineering or the field of marine organisms could not obtain the technical characteristics of close correlation between the technology of mixing the dark pigment into the concrete to change the color, the technology of modifying the bovine bone powder, the technology of grinding, the technology of using bicarbonate and the technology of controlling the permeability of the concrete and the concrete with the capability of efficiently inducing the settlement of the oysters and high durability concrete from the comparison documents 1-3. The technicians also cloud not obtain the technical characteristics of close correlation between the balance between the reduction of the alkalinity of the concrete and the concentration of calcium ions and the settlement of the marine sessile organisms from the comparison document 4.

Examples A1 to A14 had the same implementation methods. They were designed and prepared as concrete oyster settlement substrate with different shapes, as shown in FIG. 5-7. Their concrete mix proportion is as follows:

Example A1: According to the concrete mix of ordinary Portland cement, the mix ratios by weight of ordinary Portland cement, lightweight coarse aggregate, lightweight fine aggregate, water and polycarboxylate super plasticizer powder were 29.37%, 33.53%, 24.48%, 12.59% and 0.03% in a sequence.

Wherein the lightweight coarse aggregate was one or two of crushed lightweight porous basalt and lightweight ceramsite of which the maximum particle size was less than 20 mm. The lightweight fine aggregate was one or two of crushed zeolite and lightweight ceramic sand, had the particle size of 0.2 to 5 mm and was well graded. The water should meet the concrete water standard (JGJ63-2006), the Cl− content was less than 1,000 mg/L, the pH value was more than 4.5, and the influence on the initial setting time, final setting time, strength and permeability of cement was small. In the Examples A1 to A15, the above materials were the same.

Example A2: According to the reference concrete mix, the mix ratios by weight of ordinary Portland cement, silica fume, blast furnace slag powder, lightweight coarse aggregate, lightweight fine aggregate, water and polycarboxylate super plasticizer powder were 17.62%, 1.47%, 10.28%, 33.53%, 24.48%, 12.59% and 0.03% in a sequence.

Example A3: The mix ratios by weight of an unmodified dark pigment, ordinary Portland cement, silica fume, blast furnace slag powder, lightweight coarse aggregate, lightweight fine aggregate, water and polycarboxylate super plasticizer powder were 1.47%, 17.62%, 1.29%, 8.99%, 33.53%, 24.48%, 12.59% and 0.03% in a sequence.

Example A4: The mix ratios by weight of a modified dark pigment (the mass ratio of iron oxide black to an aniline black mixture was 1:1), ordinary Portland cement, silica fume, blast furnace slag powder, lightweight coarse aggregate, lightweight fine aggregate, water and polycarboxylate super plasticizer powder were 0.87%, 17.62%, 1.36%, 9.52%, 33.53%, 24.48%, 12.59% and 0.03% in a sequence.

Example A5: The mix ratios by weight of a modified dark pigment (the mass ratio of iron oxide black to an aniline black mixture was 1:1), ordinary Portland cement, silica fume, blast furnace slag powder, lightweight coarse aggregate, lightweight fine aggregate, water and polycarboxylate super plasticizer powder were 1.47%, 17.62%, 1.29%, 8.99%, 33.53%, 24.48%, 12.59% and 0.03% in a sequence.

Example A6: The mix ratios by weight of a modified dark pigment (the mass ratio of iron oxide black to an aniline black mixture was 1:1), ordinary Portland cement, silica fume, blast furnace slag powder, lightweight coarse aggregate, lightweight fine aggregate, water and polycarboxylate super plasticizer powder were 2.35%, 17.62%, 1.17%, 8.23%, 33.53%, 24.48%, 12.59% and 0.03% in a sequence.

Wherein the modified dark pigment was prepared by the following steps: mixing 196 transparent resin, 3% of a hardener and 1.5% of an accelerator, wherein the volume ratio of the pigment to the resin was 1:0.2, curing at a normal temperature for 4 h, curing at 60° C. for 4 h, breaking, and grinding with a vibration mill until the fineness was greater than 400 meshes.

Example A7: The mix ratios by weight of calcium carbonate powder, ordinary Portland cement, silica fume, blast furnace slag powder, lightweight coarse aggregate, lightweight fine aggregate, water and polycarboxylate super plasticizer powder were 0.87%, 17.62%, 1.36%, 9.52%, 33.53%, 24.48%, 12.59% and 0.03% in a sequence.

Example A8: The mix ratios by weight of calcium carbonate powder, ordinary Portland cement, silica fume, blast furnace slag powder, lightweight coarse aggregate, lightweight fine aggregate, water and polycarboxylate super plasticizer powder were 1.47%, 17.62%, 1.29%, 8.99%, 33.53%, 24.48%, 12.59% and 0.03% in a sequence.

Example A9: The mix ratios by weight of calcium carbonate powder, ordinary Portland cement, silica fume, blast furnace slag powder, lightweight coarse aggregate, lightweight fine aggregate, water and polycarboxylate super plasticizer powder were 2.35%, 17.62%, 1.17%, 8.23%, 33.53%, 24.48%, 12.59% and 0.03% in a sequence.

Example A10: The mix ratios by weight of a modified dark pigment (the mass ratio of iron oxide black to an aniline black mixture was 1:1), calcium carbonate powder, ordinary Portland cement, silica fume, blast furnace slag powder, lightweight coarse aggregate, lightweight fine aggregate, water and polycarboxylate super plasticizer powder were 1.47%, 0.87%, 17.62%, 1.18%, 8.23%, 33.53%, 24.48%, 12.59% and 0.03% in a sequence.

Example A11: The mix ratios by weight of a modified dark pigment (the mass ratio of iron oxide black to an aniline black mixture was 1:1), calcium carbonate powder, ordinary Portland cement, silica fume, blast furnace slag powder, lightweight coarse aggregate, lightweight fine aggregate, water and polycarboxylate super plasticizer powder were 1.47%, 1.47%, 17.62%, 1.10%, 7.71%, 33.53%, 24.48%, 12.59% and 0.03% in a sequence.

Example A12: The mix ratios by weight of a modified dark pigment (the mass ratio of iron oxide black to an aniline black mixture was 1:1), calcium carbonate powder, ordinary Portland cement, silica fume, blast furnace slag powder, lightweight coarse aggregate, lightweight fine aggregate, water and polycarboxylate super plasticizer powder were 1.47%, 2.35%, 17.62%, 0.99%, 6.94%, 33.53%, 24.48%, 12.59% and 0.03% in a sequence.

Example A13: The mix ratios by weight of calcium carbonate powder, zinc sulfate, a modified dark pigment (the mass ratio of iron oxide black to an aniline black mixture was 1:1), ordinary Portland cement, blast furnace slag powder, silica fume, lightweight coarse aggregate, lightweight fine aggregate, water and polycarboxylate super plasticizer powder were 2.35%, 0.5%, 1.47%, 17.62%, 0.93%, 6.50%, 33.53%, 24.48%, 12.59% and 0.03% in a sequence.

Example A14: The mix ratios by weight of calcium carbonate powder, zinc sulfate, a modified dark pigment (the mass ratio of iron oxide black to an aniline black mixture was 1:1), ordinary Portland cement, blast furnace slag powder, silica fume, lightweight coarse aggregate, lightweight fine aggregate, water and polycarboxylate super plasticizer powder were 2.35%, 1.2%, 1.47%, 17.62%, 0.84%, 5.89%, 33.53%, 24.48%, 12.59% and 0.03% in a sequence.

The preparation method of modified zinc sulfate comprises the following steps: selecting diatomite with SiO2 content of more than 90% and fineness of 600 meshes, adding 150 g of water into a stirrer at 60° C., then adding 100 g of zinc sulfate, stirring until the zinc sulfate was completely dissolved, and standing for later use; and then heating 150 g of diatomite to 60° C., adding the diatomite into the solution, stirring for 10 min in a stirrer at a rotating speed of 200-500 rpm, and then drying in a drying oven with a temperature of 100° C., thus obtaining the modified zinc sulfate.

The implementation method of the Examples A1-A14 comprised the following specific operation steps:

Three disc samples with size of (100×50 mm and five plate samples with the diameter of 200×200×30 mm were prepared according to the above preparation method of a lightweight concrete settlement substrate for oyster, and were used for respectively testing the chloride ion penetration resistance of the concrete for 28 d and the settlement and metamorphosis conditions of oyster larvae in a laboratory after standard curing for 28 d. The specific operation steps were as follows:

### (I) Molding of Samples

1, Portland cement, lightweight coarse aggregate, lightweight fine aggregate, water, dark pigment, calcium carbonate powder, trace elements and polycarboxylate super plasticizer powder were accurately calculated and weighed according to the above mass;

2, The lightweight coarse aggregate and the lightweight fine aggregate were put into a concrete mixer for mixing for 0.5-1 min; then the Portland cement, the calcium carbonate powder, the trace elements and the dark pigment were added and continuously mixed for 0.5-1 min; the water and the super plasticizer were added and mixed for 2-6 min; after obtaining desired homogeneity, casting, consolidating and demolding were performed to obtain three disc samples with the size of (100×50 mm and five plate samples with the size of 200×200×30 mm; samples were placed in a curing room for 28 days; corresponding permeability evaluation was performed at each age, and oyster larva settlement and metamorphosis experiments were performed in a laboratory after 28 d.

### (II) Specific Steps of a Rapid Chloride Ion Penetration Experiment:

According to “Standard Test for Electrical Indication of Concrete's Ability to Resist Chloride Ion Penetration” (ASTM1202-2017), when standard curing was carried out for 28 d, three disc samples with the diameter of (D100×50 mm were taken out from a curing chamber respectively, water and impurities on the surfaces of the disc samples were cleaned, and after the surfaces of the disc samples were dried, and the side surfaces of the disc samples were coated with a thin layer of epoxy resin. Then the samples were put into a vacuum water saturation machine for 20-24 h. The samples were taken out, the surfaces of the samples were cleaned, and the samples were put into polymethyl methacrylate molds, and after the sealing property between the samples and the molds was detected, a sodium chloride solution (an electrode was connected with a negative electrode of a power supply) with the mass concentration of 3% and a sodium hydroxide solution (an electrode was connected with a positive electrode of the power supply) with the molar concentration of 0.3 mol/L were respectively placed into the molds on the two sides. An experimental instrument was started, experimental data were recorded after 6 h, and the operations were repeated on the two subsequent samples. Finally, electric flux calculation was carried out according to specifications.

### (III) Specific Step of an Indoor Settlement and Metamorphosis Experiment of Oyster Larvae

After standard curing was carried out for 28 d, plate samples with the sizes of 200×200×30 mm were taken out from the curing room respectively, and water and impurities on the surfaces of the samples were cleaned; then the samples were put into a test pool, and the test pool was prepared in a laboratory, wherein the abundance of the oyster larvae was 0.85 ind/ml³, seawater in the pool was sand-filtered Huang Hai seawater, and the salinity was about 32-34%; after the water level of the seawater was higher than that of the concrete samples, oxygen pipes were uniformly distributed into the test pool, and the oyster larvae were prepared to be put into the test pool. After the oyster larvae were slowly and uniformly mixed in a water bucket, the mass of the seawater containing the oyster larvae was accurately weighed by using a beaker, and then the seawater was uniformly distributed into the test pool.

After an oyster settlement induction test was started, seawater in the test pool was replaced every day, the water replacement amount was ⅓ of the total capacity of the test pool, a sieve (larger than or equal to 200 meshes) was used for blocking a water outlet, non-settled oyster larvae were prevented from being lost along with water, the larvae on the sieve were put into the test pool again, chlorella was fed regularly and quantitatively through a rubber head dropper at 9 a.m. and 7 p.m. every day, and the oyster settlement condition was observed.

After the test lasts for 30 days, water in the test pool was drained, the samples were taken out, the number on the surfaces of the samples were counted, recorded and survival rate of the oysters on the surfaces of the samples were analyzed, and the smooth bottom face in concrete casting molding was taken during counting.

Compared with a comparison document 3 (Fan Ruiliang. Effect of the Substrate Types on Oyster Settlement, Growth, Population Establishment and Reef Development [D]), the difference was that:

In the comparison document 3, 80-mesh bovine bone powder, calcium powder and gypsum powder were used and independently added into the concrete. The fineness of all calcium materials added in the present disclosure was larger than 100 meshes and was larger than that of the materials in the comparison document 3. The purpose is to give full play to their inducing ability while considering the particle gradation of concrete.

In the example, 600 mesh calcium carbonate powder is used to prepare concrete, which has a large fineness. After being added into the concrete, it has little impact on the property of the concrete. Calcium carbonate powder can be better dispersed into the concrete and increase the settlement rate of oyster larvae.

The comparison documents and consulted literature data showed that the calcium content was very important for the settlement of the oyster larvae, and some experimental results at present also proved that the settlement and the growth of the oyster larvae could be promoted by adding a proper dosage of calcium carbonate substances into a cement-based material. However, cement concrete contained a large number of calcium ions, the pH value in a pore solution was generally greater than 12.5, and the pH value of a saturated calcium hydroxide solution was about 12 at normal temperature, thus the concentration of the calcium ions in the pore solution of the concrete was about 5 mmol/L; and the solubility of calcium carbonate was very small and was only 9.5×10−5 mol/L (9.5×10−2 mmol/L) at 25° C. At present, the optimal range of the concentration of the calcium ions for inducing the settlement of the oysters was 10-25 mmol/L, and even if the oyster larvae were placed in the saturated calcium carbonate solution, the concentration of Ca2+ was not enough to provide the appropriate ion concentration for the settlement of the oysters. Further, Ca(OH)₂ in the cement concrete could be released more quickly, and the dissolution of the calcium carbonate needed a longer time. Therefore, it could be understood or inferred that the calcium carbonate material added into the concrete could promote the settlement of the oyster larvae, and the Ca²⁺ did not play a leading role. The early settlement and metamorphosis of the oysters were related to HCO₃₋, and the secondary shells of the calcium carbonate were generated by HCO₃₋ together with the Ca²⁺ during metamorphosis. After the calcium carbonate was added, the calcium carbonate reacted with CO₂ and water to generate Ca(HCO₃)₂ to participate in the settlement, which was a fundamental mechanism for promoting the settlement of the oyster larvae.

There was an optimum dosage in the dosage of calcium carbonate in the cement-based material, which could be explained from the following three aspects:

1) For equivalent substituted cement, the alkali in the concrete was diluted along with the increase of the dosage of the calcium carbonate, and the total alkalinity was reduced; however, along with the increase of the dosage of the calcium carbonate, the dissolution probability of the calcium carbonate in the concrete was increased, and the content of HCO₃₋ in the solution was increased, thus the settlement and the metamorphosis of the oysters were promoted; however, when the dosage was too large, the permeability of the concrete was increased sharply, and the alkali and carbonate radicals in the concrete were quickly leached, so that the negative effect of the alkali was prominent, and the critical or negative effect of the carbonate radicals was initially prominent, thus the settlement amount was reduced;

2) For equivalent substituted aggregate, the permeability of the concrete was reduced along with the increase of the dosage, consequently, the leach of calcium ions and OH− was reduced, but the leach rate of carbonate ions was gradually increased first, and when the leach rate reached a certain value, oyster settlement reached a maximum value; and along with the continuous increase of the dosage, the reduction amplitude of the calcium ions was large, and the carbonate radicals were possibly reduced, thus the settlement of the oyster larvae was limited by the concentration of the calcium ions, and the settlement was reduced;

3) For equivalent substituted mineral admixture, the permeability was increased along with the increase of the dosage, and a proper HCO₃₋ concentration range suit for the oyster settlement was obtained due to the increase of calcium carbonate, which indicated the increase of the settled oyster larvae; and along with the continuous increase of the dosage of the mineral admixture, the dosage of the mineral admixture was reduced, so the amount of leaching alkali was increased, the carbonate radicals were increased, and the settlement of the oyster larvae was inhibited by excessive alkali and HCO₃₋ ions.

Compared with a comparison document 4 (Li Zhenzhen, Gong Pihai, Guan Changtao, et al, Study on the Organisms Settlement of Artificial Reefs Constructed with Five Different Cements[J]. Progress in Fishery Sciences, 2017, 38(5):57-63], the difference was that:

In the comparison document 4, composite Portland cement, slag Portland cement, pozzolanic Portland cement, fly ash Portland cement and aluminate cement were used. In the present disclosure, low-alkalinity cement was achieved by mixing ordinary Portland cement and the mineral admixture; silica fume was one of the mineral admixtures and had high activity, and optimum dosage of silica fume could achieve obvious effect on increasing the durability of reinforced concrete in the marine environment. Low-alkalinity cement with the excellent strength and durability could be obtained through optimization design and experiments. Meanwhile, by means of the high penetration resistance characteristic of the silica fume concrete, even if the alkalinity in the concrete was high, a large number of oyster larvae still settled to, metamorphosized and grew on the concrete surface. The low-alkalinity sulphoaluminate cement was compounded to regulate and control the alkalinity of the cement concrete, and thus an appropriate pH value was provided for oyster larva settlement. In addition, compared to marine plants, oysters, barnacles and other sessile organisms were different in alkali resistance, the environments needed in the settlement period and later period were different, for example, a large number of calcium ions were needed for settlement, metamorphosis and later-period growth of the barnacles and the oysters.

In the comparison document 4, the concrete was used for enriching marine organisms, focusing on the amount and diversity of settled biomass, and the mainly settled organisms were various algae and the like. The research objective of the present disclosure was to induce the settlement of the oysters, but the alkalinity tolerance of oysters and barnacles was higher than that of algae, and a large amount of calcium ions were needed for settlement and metamorphosis of the oysters, so that the two kinds of concrete looked like the same, but in fact there was a big difference. FIG. 3 and FIG. 4 respectively showed the oyster settlement comparison conditions between the comparison document 4 after performing the real sea settlement experiment for about 210 d and the present disclosure after performing the real sea settlement experiment for 300 d.

In addition, the present disclosure has the unique characteristics and the following beneficial effects:

### Dark Pigment

The light-shielding characteristic of oyster eyespot larvae was utilized, the dark pigment (one or two of iron oxide black, nigrosine, carbon black, antimony sulfide, iron oxide red and organic pigment red) were modified and doped into the concrete, the color of the concrete was changed and darkened, the concrete was regarded as a dark environment by the oyster larvae, thus the oyster larvae were induced to reach the dark concrete surface, the contact probability of the larvae and the concrete surface were increased, and the induced settlement rate of the oyster larvae was increased. Specifically:

Marine organism researchers carried out the research on the settlement of marine sessile organisms by substrates with different colors in order to cultivation and propagation or eliminate unexpected populations, which belonged to the marine organism discipline. The marine organism discipline was quite different from the marine concrete engineering or concrete material discipline, they were completely two major disciplines. Through the crossing of the marine sessile organism discipline and the concrete discipline, the induced settlement of the oyster larvae by dark concrete was realized. In the present disclosure, the dark pigment was added to deepen the surface color of concrete so as to promote the settlement of the oyster larvae. Other materials were added in the concrete, which could affect the properties of the concrete. In the present disclosure, in consideration of the concrete of different cements, there was a difference in surface color of the concrete. Therefore, the dosage of the dark substances could be determined according to the type and dosage of the cement. The dark pigment also affected the properties of the concrete. Most importantly, when the dark pigment was added, if the penetration rates of alkali, Ca²⁺ and the like in the concrete were not controlled, the leached alkali could affect the settlement, metamorphosis and growth of the sessile organism larvae, and when the dosage was greater than a certain value, the settlement amount of the larvae was reduced. In the present disclosure, the penetration resistance of the concrete was designed and controlled, and the main measures were as follows: selection of the type of the dark pigment, control of the dosage and modification. With the increase of the dosage of the dark pigment, the settlement rate of the larvae was increased first, and when the dosage accounted of 0.5-6% of the cementitious material, the settlement amount of the larvae was maximum, but was slightly increased or kept unchanged later.

### Trace Elements

A large amount of zinc was enriched in the oyster body, and zinc concentration was far higher than that in the seawater in which the oyster lives, and meanwhile, the oyster body further contains more Fe, P and K elements. Meanwhile, proper concentration of Zn²⁺ and K⁺ in the solution could promote early settlement and metamorphosis of the oyster larvae. Therefore, zinc sulfate, potassium sulfate, potassium nitrate, ferric sulfate, zinc phosphate, ammonium nitrate, potassium phosphate, ammonium phosphate, ferric phosphate and calcium phosphate were adopted as the trace elements to be doped into the concrete, and these substances were modified to enable the strength and the penetration resistance of the concrete to be basically kept unchanged, and thus the induced settlement rate of the oyster larvae was greatly increased. Specifically:

Marine organism researchers carried out the research on the settlement and metamorphosis of different ions to marine sessile organisms in order to clarify oyster settlement mechanisms and cultivation propagation, which belonged to the marine organism discipline. The marine organism discipline was quite different from the marine concrete engineering or concrete material discipline, they were completely two major disciplines. Through the crossing of the marine sessile organism discipline and the concrete discipline, corresponding substances were added into the concrete to induce the oyster larvae to settle on the surface of the concrete. Soluble salts had great influence on the properties of the concrete, such as influence on early workability, setting time and later strength and penetration resistance. Diatomite was adopted as a carrier in the present disclosure, the inorganic salts were fixed in the diatomite, thus the influence of the soluble salts on the properties of the concrete was reduced. Meanwhile, the effect of improving the properties of the concrete by the diatomite was utilized to keep good mechanical property and penetration resistance of the concrete when these inducing substances were added. In addition, diatomite serving as the carrier had a slow release effect, thus soluble salt was released slowly, and particularly, the release was kept at a very low rate after the diatomite was soaked in seawater for a certain period of time. Therefore, the above knowledge related to crossing of the marine sessile organism discipline, chemistry and marine concrete engineering disciplines, and technicians in the fields of concrete and engineering or the field of marine organisms could not obtain the technical characteristics of close correlation between the technology of doping the trace elements into the concrete to change the ion content of the trace elements on the surface of the concrete and control the permeability of the concrete and the concrete with the capability of efficiently inducing the settlement of the oysters through the existing background.

### Concrete Permeability

The strength and permeability of concrete were two main properties of the concrete. Different inducers added into reference concrete could influence the properties of the concrete. Therefore, when different substances were added to promote settlement, metamorphosis and later growth of the oyster larvae, it must be integrally controlled to make sure that the different substances did not have a big impact on the strength and permeability of the concrete, and then raw materials were selected according to the compatibility of various raw materials. If the properties of the raw materials could not meet the actual requirements, the raw materials were modified and then added so as to achieve the expected functions. In practice, although related research was performed by considering the influence of the dosage of calcium on oyster larva settlement, the properties of concrete, the water-cement ratio, the dosage of calcium, maintenance and the like were not considered, moreover, the leakage rate of alkali and ions in the concrete could be changed due to the change of the permeability of the concrete, the poorer the penetration resistance of the concrete was, the higher the leakage rate of the alkali and the ions in the concrete was, and the leakage rate might be exponentially increased. Therefore, the leached alkali and ions could greatly influence the larvae, a change from promoting settlement to inhibiting settlement might occur, and particularly when the content of cement was large, the situation was more serious. Therefore, when the inducer was added into the concrete, it must be guaranteed that the change of the penetration resistance of the concrete was within a controllable range, for example, the change could not exceed 10%. In this way, the induction effects could be compared, otherwise, the influence of single inducer addition or inducer composite addition on the induction effect of the oyster larvae could not be evaluated.

Only the optimum environment required by settlement, metamorphosis and later growth of marine sessile organisms was mastered, and concrete could be designed from the penetration resistance level of the concrete instead of only considering the dosage of various raw materials and ignoring the penetration resistance change of the concrete. Therefore, the above knowledge related to crossing of the marine sessile organism discipline, chemistry and marine concrete engineering disciplines. Technicians in the field of concrete, engineering or marine biology cannot obtain the technical characteristics of the present disclosure through the existing background, which relates to the close relationship between the overall control of the penetration resistance of the concrete and the inducer's ability to promote the efficient adhesion of oysters.

In the present disclosure, the weight of the concrete settlement substrate can be reduced by lightweight aggregate concrete, and the costs of transportation, labor and the like can be reduced in the processes of preparation, transportation and maintenance of samples. The labor cost of fishermen moving the settlement substrate and harvesting the oysters can be reduced or the costs of transportation, fixing and the like can be reduced during sea farming. The risk of breaking due to careless falling onto the ground during use can be reduced.

Additionally or Alternatively, the dark pigment is one or two of iron oxide black, nigrosine, carbon black, antimony sulfide, iron oxide red and organic pigment red.

Additionally or Alternatively, the above dark pigments are modified according to the influence degree on the concrete properties; and one of transparent resin, organosilicon, dimethylsiloxane and a super hydrophobic material is used for modification treatment.

Additionally or Alternatively, the biological calcium powder is bovine bone powder, and the biological calcium carbonate powder comprises one or more of oyster shell powder, fishbone powder, egg shell powder and coral powder, with fineness of 100-1,000 meshes.

Additionally or Alternatively, the biological calcium powder is obtained by treating the 100-500-mesh egg shell powder, coral powder, oyster shell powder and fishbone powder with one or two of acetic acid, silicic acid and sulfurous acid, and by treating the 100-500-mesh bovine bone powder with one or two of diluted phosphoric acid, sulfuric acid, hydrochloric acid and nitric acid.

Additionally or Alternatively, the modified carbonate (or bicarbonate) is one or more of sodium carbonate, potassium carbonate, calcium bicarbonate, sodium bicarbonate and potassium bicarbonate. Diatomite is used as a carrier and mixed with these inorganic salts to realize the slow-release of corresponding ions and reduce or eliminate the adverse effects on the property of concrete.

Additionally or Alternatively, the Portland cement is ordinary Portland cement with strength grade >32.5. The mineral admixture includes one or a combination of more of silica fume, slag and fly ash.

Additionally or Alternatively, sand is one or more of river sand, machine-made sand (basalt or granite as parent rock) or desalinated sea sand with fine gradation.

A preparation method of a Portland cement concrete settlement substrate for oyster comprises the following steps:

S1, designing different roughness according to the characteristic that oyster larvae prefer to settle to rough substrate surface, and then manufacturing molding from works with different roughness;

S2, weighing Portland cement, a mineral admixture, coarse aggregate, sand, water, a dark pigment, biological calcium powder, modified carbonate (or bicarbonate) and a super plasticizer.

S3, firstly putting the coarse aggregate and the sand into a concrete mixer to be mixed for 0.5-1 min; then adding the Portland cement, the mineral admixture, the dark pigment, the biological calcium powder, and the modified carbonate (or bicarbonate), and continuously mixing for 1-2 min; then adding the water and the super plasticizer, and mixing for 2-6 min; then carrying out casting and consolidating after obtaining desired homogeneity; and

S4, putting a concrete sample after demolding into a high-concentration CO₂ curing chamber for curing for 0.5-5 h according to the situation so as to reduce the alkalinity of the concrete sample, and then carrying out standard curing for 28 d or curing according to the actual situation.

Thus, the Portland concrete settlement substrate for oyster with a good induction effect can be prepared.

The material 2 comprises the following components in percentage by weight: 0.3-2.0% of a dark pigment, 9.0-17.0% of Portland cement, 4.0-11.5% of a mineral admixture, 38.4-47.8% of crushed stone, 24.9-37.3% of sand, 6.2-9.0% of water, and 0.02-0.1% of a super plasticizer.

The material 3 comprises the following components in percentage by weight: 0.3-2.0% of bovine bone powder, 9.0-17.0% of Portland cement, 4.0-11.5% of a mineral admixture, 38.4-47.8% of crushed stone, 24.9-37.3% of sand, 6.2-9.0% of water, and 0.02-0.1% of a super plasticizer.

The material 4 comprises the following components in percentage by weight: 0.3-2.0% of a dark pigment, 0.3-1.5% of carbonate (or bicarbonate), 9.0-17.0% of Portland cement, 4.0-11.5% of a mineral admixture, 38.4-47.8% of crushed stone, 24.9-37.3% of sand, 6.2-9.0% of water, and 0.02-0.1% of a super plasticizer.

An objective of the present disclosure is to provide a lightweight concrete settlement substrate which can induce sessile organisms to rapidly and compactly settle on the concrete surface and has good durability, aiming at solving the problems that at present, due to the fact that water consumption control and curing (the water-cement ratio and curing determine the permeability of concrete) are not carried out, thus a large amount of alkali contained in the settlement substrate is released, the alkalinity of seawater making contact with the settlement substrate is increased, settlement of marine sessile organism larvae is restrained, and meanwhile, due to the fact that a large amount of shell powder is added, the color of the concrete settlement substrate becomes light from dark gray, and settlement of oysters is not facilitated.

The objective of the present disclosure is realized as follows: the cement dosage in the settlement substrate is reduced, a proper cement type is selected, and a proper mineral admixture is added to obtain cement with lower alkalinity. Meanwhile, the water-cement ratio of the concrete of the settlement substrate is controlled, and the release rate of alkali in the concrete is controlled. According to the preferred by settled oysters and the addition of calcium carbonate and trace elements, the early settlement, metamorphosis and later growth of the oysters are promoted. Meanwhile, the configuration design of the settlement substrate is carried out. In addition, the settlement substrate can be directly used for sessile organism larvae in the culture pond and does not need to be placed in seawater for a long time. Under the condition of no violent collision or smashing, the expected service life of the settlement substrate can be at least 50 years.

In addition, the weight of the concrete settlement substrate can be reduced by lightweight aggregate concrete, and the costs of transportation, labor and the like can be reduced in the processes of preparation, transportation and maintenance of samples. The labor cost of fishermen moving the settlement substrate and harvesting the oysters can be reduced or the costs of transportation, fixing and the like can be reduced during sea farming. The risk of breaking due to careless falling onto the ground during use can be reduced.

The present disclosure further comprises the following structural characteristics:

The material 1 comprises the following components in percentage by weight: 22.0-35.0% of a cementitious material, 25.0-38.0% of lightweight coarse aggregate, 16.0-30.0% of lightweight fine aggregate, 8.5-16.5% of water, 0.6-3.0% of dark pigment, 0.6-3.0% of calcium carbonate powder, 0.2-1.8% of trace elements, and 0.03-0.18% of a super plasticizer.

Additionally or Alternatively, the dark pigment is one or two of iron oxide black, nigrosine, carbon black, antimony sulfide, iron oxide red and organic pigment red.

Additionally or Alternatively, the above dark pigments are modified according to the influence degree on the concrete properties; and one of transparent resin, organosilicon, dimethylsiloxane and a super hydrophobic material is used for modification treatment.

Additionally or Alternatively, the trace elements that are zinc, iron, potassium and phosphorus are selected from natural minerals, industrial products or chemical reagents, including one or more of zinc sulfate, calcium phosphate, zinc phosphate, potassium sulfate, potassium nitrate, ferric sulfate, ammonium nitrate, potassium phosphate, ammonium phosphate and ferric phosphate, and are modified to realize slow release of corresponding ions and to reduce or eliminate adverse effects on the concrete properties. However, for eutrophic areas, substances containing nitrogen and phosphorus elements are not selected.

Additionally or Alternatively, the calcium carbonate powder is calcite powder, chalk powder, limestone powder, marble powder, aragonite powder, travertine powder, and one or more of processed lightweight calcium carbonate, active calcium carbonate, calcium carbonate whiskers and ultrafine lightweight calcium carbonate, with fineness of greater than 200 meshes.

Additionally or Alternatively, the lightweight coarse aggregate is one or two of crushed lightweight porous basalt and lightweight ceramsite of which the maximum particle size is less than 20 mm.

Additionally or Alternatively, and the lightweight fine aggregate is one or two of crushed zeolite and lightweight ceramic sand, with a particle size of 0.2 to 5 mm.

Additionally or Alternatively, the cementitious material is one of mineral admixture added Portland cement, sulphoaluminate cement and an alkali-activated cementitious material.

The mineral admixture in the mineral admixture added Portland cement comprises one or a combination of more of silica fume, slag powder and fly ash; the sulphoaluminate cement comprises one or two of rapid hardening sulphoaluminate cement, high-strength sulphoaluminate cement and expansive sulphoaluminate cement; and the alkali-activated cementitious material comprises one of alkali-activated slag powder, and a combination of alkali-activated slag powder and fly ash.

A preparation method of a lightweight concrete settlement substrate for oyster comprises the following steps:

S1, accurately weighing a cementitious material, lightweight coarse aggregate, lightweight fine aggregate, water, a dark pigment, calcium carbonate powder, trace elements, and a super plasticizer;

S2, firstly putting the lightweight coarse aggregate and the lightweight fine aggregate into a concrete mixer to be mixed for 0.5-1 min; then adding the cementitious material, the dark pigment, the calcium carbonate powder and the trace elements, and continuously mixing for 0.5-1 min; then adding the water and the super plasticizer, and mixing for 2-6 min; then carrying out casting and consolidating after obtaining desired homogeneity.

Thus, the lightweight concrete settlement substrate for oyster with a good induction effect can be prepared.

The material 2 comprises the following components in percentage by weight: 0.6-3.0% of a dark pigment, 22.0-35.0% of a cementitious material, 25.0-38.0% of lightweight coarse aggregate, 16.0-30.0% of lightweight fine aggregate, 8.5-16.5% of water and 0.03-0.18% of a super plasticizer.

The material 3 comprises the following components in percentage by weight: 0.6-3.0% of calcium carbonate powder, 22.0-35.0% of a cementitious material, 25.0-38.0% of lightweight coarse aggregate, 16.0-30.0% of lightweight fine aggregate, 8.5-16.5% of water and 0.03-0.18% of a super plasticizer.

The material 4 comprises the following components in percentage by weight: 0.6-3.0% of a dark pigment, 0.6-3.0% of calcium carbonate powder, 22.0-35.0% of a cementitious material, 25.0-38.0% of lightweight coarse aggregate, 16.0-30.0% of lightweight fine aggregate, 8.5-16.5% of water and 0.03-0.18% of a super plasticizer.

Compared with the prior technology, the present disclosure has the beneficial effects that:

In the present disclosure, a diluted acid modification technology and a composite grinding technology are adopted in a control way, the induction capability of the bovine bone powder is fully exerted, the dosage of the bovine bone powder is greatly reduced, and anti-corrosion treatment and modification are carried out, so that a composite inducer taking the bovine bone powder as a main component is realized, the dosage of the composite inducer is small, the strength and permeability of concrete are hardly influenced, meanwhile, the composite inducer has significant inductive effect on larval settlement, and the problem of mildewing of the concrete is solved. Similarly, by controlling the fineness and content of calcium carbonate powder, the water cement ratio of concrete and adding dark pigment, the strength and permeability of concrete are hardly affected. Compared with concrete without the inducer, the concrete with the inducer enables the number of settled oyster larvae to be obviously increased.

In the present disclosure, the weight of the concrete settlement substrate can be reduced by lightweight aggregate concrete, and the costs of transportation, labor and the like can be reduced in the processes of preparation, transportation and maintenance of samples. The labor cost of fishermen moving the settlement substrate and harvesting the oysters can be reduced or the costs of transportation, fixing and the like can be reduced during sea farming. The risk of breaking due to careless falling onto the ground during use can be reduced.

Therefore, the above knowledge related to crossing of the marine sessile organism discipline, marine plants and marine concrete engineering disciplines, and technicians in the fields of concrete and engineering or the field of marine organisms could not obtain the technical characteristics of close correlation between the technology of mixing the dark pigment into the concrete to change the color, the technology of adding calcium carbonate powder and trace elements, and the technology of controlling the permeability of the concrete and the concrete with the capability of efficiently inducing the settlement of the oysters and high durability concrete from the comparison documents 3. The technicians also cloud not obtain the technical characteristics of close correlation between the balance between the reduction of the alkalinity of the concrete and the concentration of calcium ions and the settlement of the marine sessile organisms from the comparison document 4.

Although examples of the present disclosure have been shown and described, it would be understood by those skilled in the art that various changes, modifications, and substitutions could be made in these embodiments without departing from the principle and spirit of the present disclosure and modifications, the scope of the present disclosure was defined by the appended claims and their equivalents.

1. A Portland cement concrete settlement substrate for oyster, comprising the following components in percentage by weight: 9.0-17.0% of Portland cement, 4.0-11.5% of a mineral admixture, 38.4-47.8% of coarse aggregate, 24.9-37.3% of sand, 6.2-9.0% of water, 0.3-2.0% of a dark pigment, 0.3-2.0% of biological calcium powder, 0.3-1.5% of carbonate (or bicarbonate) and 0.02-0.1% of a super plasticizer.

2. The Portland cement concrete settlement substrate for oyster according to claim 1, wherein the dark pigment is one or two of iron oxide black, nigrosine, carbon black, antimony sulfide, iron oxide red and organic pigment red.

3. The Portland cement concrete settlement substrate for oyster according to claim 2, wherein the dark pigment is modified according to the influence degree on the concrete properties; and one of transparent resin, organosilicon, dimethylsiloxane and a super hydrophobic material is used for modification treatment.

4. The Portland cement concrete settlement substrate for oyster according to claim 1, wherein the biological calcium powder is bovine bone powder; and the biological calcium carbonate powder comprises one or a combination of more of oyster shell powder, fishbone powder, egg shell powder and coral powder, with a fineness of 100-1,000 meshes.

5. The Portland cement concrete settlement substrate for oyster according to claim 4, wherein the biological calcium powder is obtained by treating the 100-500-mesh egg shell powder, coral powder, oyster shell powder and fishbone powder with one or two of acetic acid, silicic acid and sulfurous acid, and by treating the 100-500-mesh bovine bone powder with one or two of diluted phosphoric acid, sulfuric acid, hydrochloric acid and nitric acid.

6. The Portland cement concrete settlement substrate for oyster according to claim 1, wherein the carbonate (or bicarbonate) is one or more of sodium carbonate, potassium carbonate, calcium bicarbonate, sodium bicarbonate and potassium bicarbonate; and diatomite is used as a carrier and mixed with these inorganic salts to realize the slow-release of corresponding ions and reduce or eliminate the adverse effects on the property of concrete.

7. The Portland cement concrete settlement substrate for oyster according to claim 1, wherein the Portland cement is ordinary Portland cement with strength grade >32.5; and the mineral admixture includes one or more combinations of silica fume, slag and fly ash.

8. A preparation method of a Portland cement concrete settlement substrate for oyster, comprising the following steps:
S1, designing different roughness according to the characteristic that oyster larvae prefer to settle to rough substrate surface, and then manufacturing molding from works with different roughness;
S2, weighing Portland cement, a mineral admixture, coarse aggregate, sand, water, a dark pigment, biological calcium powder, modified carbonate (or bicarbonate) and a super plasticizer.
S3, firstly putting the coarse aggregate and the sand into a concrete mixer to be mixed for 0.5-1 min; then adding the Portland cement, the mineral admixture, the dark pigment, the biological calcium powder, and the modified carbonate (or bicarbonate), and continuously mixing for 1-2 min; then adding the water and the super plasticizer, and mixing for 2-6 min; then carrying out casting and consolidating after obtaining desired homogeneity; and
S4, putting a concrete sample after demolding into a high-concentration CO₂ curing chamber for curing for 0.5-5 h according to the situation so as to reduce the alkalinity of the concrete sample, and then carrying out standard curing for 28 d or curing according to the actual situation.

9. The Portland cement concrete settlement substrate for oyster according to claim 1, wherein the settlement substrate for oyster comprises the following components in percentage by weight: 0.3-2.0% of a dark pigment, 9.0-17.0% of the Portland cement, 4.0-11.5% of the mineral admixture, 38.4-47.8% of crushed stone, 24.9-37.3% of sand, 6.2-9.0% of water, and 0.02-0.1% of the super plasticizer.

10. The Portland cement concrete settlement substrate for oyster according to claim 1, wherein the settlement substrate for oyster comprises the following components in percentage by weight: 0.3-2.0% of bovine bone powder, 9.0-17.0% of the Portland cement, 4.0-11.5% of the mineral admixture, 38.4-47.8% of crushed stone, 24.9-37.3% of sand, 6.2-9.0% of water, and 0.02-0.1% of the super plasticizer.

11. The Portland cement concrete settlement substrate for oyster according to claim 1, wherein the settlement substrate for oyster comprises the following components in percentage by weight: 0.3-2.0% of the dark pigment, 0.3-1.5% of carbonate (or bicarbonate), 9.0-17.0% of the Portland cement, 4.0-11.5% of the mineral admixture, 38.4-47.8% of crushed stone, 24.9-37.3% of sand, 6.2-9.0% of water, and 0.02-0.1% of the super plasticizer.

12. A lightweight concrete settlement substrate for oyster, comprising the following components in percentage by weight: 22.0-35.0% of a cementitious material, 25.0-38.0% of lightweight coarse aggregate, 16.0-30.0% of lightweight fine aggregate, 8.5-16.5% of water, 0.6-3.0% of a dark pigment, 0.6-3.0% of calcium carbonate powder, 0.2-1.8% of trace elements, and 0.03-0.18% of a super plasticizer.

13. The lightweight concrete settlement substrate for oyster according to claim 12, wherein the dark pigment is one or two of iron oxide black, nigrosine, carbon black, antimony sulfide, iron oxide red and organic pigment red.

14. The lightweight concrete settlement substrate for oyster according to claim 13, wherein the dark pigment is modified according to the influence degree on the concrete properties; and one of transparent resin, organosilicon, dimethylsiloxane and a super hydrophobic material is used for modification treatment.

15. The lightweight concrete settlement substrate for oyster according to claim 12, wherein the calcium carbonate powder is calcite powder, chalk powder, limestone powder, marble powder, aragonite powder, travertine powder, and one or more of processed lightweight calcium carbonate, active calcium carbonate, calcium carbonate whiskers and ultrafine lightweight calcium carbonate, with fineness of greater than 200 meshes.

16. The lightweight concrete settlement substrate for oyster according to claim 12, wherein the trace elements that are zinc, iron, potassium and phosphorus are selected from natural minerals, industrial products or chemical reagents, including one or more of zinc sulfate, calcium phosphate, zinc phosphate, potassium sulfate, potassium nitrate, ferric sulfate, ammonium nitrate, potassium phosphate, ammonium phosphate and ferric phosphate, and are modified to realize slow release of corresponding ions and to reduce or eliminate adverse effects on the concrete properties.

17. The lightweight concrete settlement substrate for oyster according to claim 12, wherein the cementitious material is one of mineral admixture added the Portland cement, sulphoaluminate cement and an alkali-activated cementitious material; the mineral admixture in the mineral admixture added Portland cement comprises one or a combination of more of silica fume, slag powder and fly ash; the sulphoaluminate cement comprises one or two of rapid hardening sulphoaluminate cement, high-strength sulphoaluminate cement and expansive sulphoaluminate cement; and the alkali-activated cementitious material comprises one of alkali-activated slag powder, and a combination of alkali-activated slag powder and fly ash.

18. The lightweight concrete settlement substrate for oyster according to claim 12, wherein the settlement substrate for oyster comprises the following components in percentage by weight: 0.6-3.0% of the dark pigment, 22.0-35.0% of the cementitious material, 25.0-38.0% of the lightweight coarse aggregate, 16.0-30.0% of the lightweight fine aggregate, 8.5-16.5% of the water and 0.03-0.18% of the super plasticizer.

19. The lightweight concrete settlement substrate for oyster according to claim 12, wherein the settlement substrate for oyster comprises the following components in percentage by weight: 0.6-3.0% of the calcium carbonate powder, 22.0-35.0% of the cementitious material, 25.0-38.0% of the lightweight coarse aggregate, 16.0-30.0% of the lightweight fine aggregate, 8.5-16.5% of water and 0.03-0.18% of the super plasticizer.

20. The lightweight concrete settlement substrate for oyster according to claim 12, wherein the settlement substrate for oyster comprises the following components in percentage by weight: 0.6-3.0% of the dark pigment, 0.6-3.0% of the calcium carbonate powder, 22.0-35.0% of the cementitious material, 25.0-38.0% of the lightweight coarse aggregate, 16.0-30.0% of the lightweight fine aggregate, 8.5-16.5% of water and 0.03-0.18% of the super plasticizer.
